(19) United States
(12) Patent Application Publication
(10) Pub. No.: US 2003/0027354 A1
(43) Pub. Date: Feb. 6, 2003

(54) Device for the analysis of chemical or biochemical specimens, comparative analysis, and associated analysis process

(76) Inventor: Francois Geli, Lyon (FR)

Correspondence Address: YOUNG & THOMPSON, 745 SOUTH 23RD STREET 2ND FLOOR, ARLINGTON, VA, 22202

(21) Appl. No.: 10/164,423

(22) Filed: Jun. 10, 2002

(30) Foreign Application Priority Data
Jun. 8, 2001 (FR) 01 07537

(51) Int. Cl. G01N 1/18

(52) U.S. Cl. 436/178; 436/177; 422/101

(57) ABSTRACT

A device for the chemical or biochemical analysis of biological or chemical samples, notably for a comparative analysis of at least two samples, comprises multiple fractionation micro-columns 2 for the fractionation of sample components, each fractionation micro-column 2 comprising at least a micro-channel 3 segment fitted with intermediate separation means, the micro-channel 3 segment comprising an inlet 3a for the introduction of a sample-enriched mobile phase and an outlet 3b for the evacuation of the fluids and situated at a teminal extremity. The device comprises also capture fluidic means 7 of the fractionated products which are located at a terminal element 9 of each fractionation micro-columns 2 and upstream from the evacuation outlet 3b, capture micro-channels 8 which are used to collect the captured fractionation products and groups of selective micro-cantilevers 13 which are associated with the fractionation micro-columns 2 and situated downstream from the capture micro-channels 8, a micro-cantilever 13 being fitted with detection means which are associated with analytical means.

The present invention describes a device for chemical and biochemical analysis of chemical or biological samples, notably for a comparative analysis of at least two samples. The invention describes also a set of comparative analyses and an analytical process

The analysis and the comparison of chemical and biochemical samples, and notably the analysis of the proteins contained in biological samples, complement the study of genes by the study of the functional expression of genes under the form of proteins.

In eukaryotes, functional genomics (the study of the gene functions) and proteomics (the study of protein functions) reveals a diversity which is much larger than the bare translation of the genetic code. Thus, in the human species, it is estimated that there are approximately 25,000 genes which can express up to one million different proteins. These functional approaches are applied as much on the search of intracellular and intercellular pathways, which include the notion of series of cellular interactions, as on the search of combinations of genes which are expressed during the series of interactions. Whether the series of cellular interactions or a combination of genes expression is considered, the post-translational modifications of expressed proteins is essential for their function and thus, should be known.

There is a need for devices which allow for the analysis and the comparison of chemical and biochemical samples, the separation of samples constituents in view of their analysis and possibly, the comparison of the constituents of two samples. Notably, the scientists often wish to compare the proteins which are expressed by several different groups of cells with different physiological or pathological status.

A method is known, in which the constituents of a sample are separated by migration in a gel. However, the limits of this method are a lack of exhaustiveness, a lack of discrimination, an insufficient reproducibility and an inability to analyse hydrophobic molecules.

The present invention is a device for chemical and biochemical sample analysis which prevent these disadvantages.

The invention is a device for chemical and biochemical analysis of samples which allows for a rapid separation of the constituents of a sample and a rapid analysis of the separated constituents, as well as the comparison of the constituents of different samples.

The invention is also a device for chemical and biochemical analysis of samples which allows for an improved separation of the constituents of a sample and notably, separations of the constituents of a sample according to different criteria of selectivity.

Such a chemical or biochemical analytical device, which is notably used for the comparative analysis of at least two samples, includes multiple micro-columns which are used for the fractionation of the constituents of a sample; each fractionation micro-column is at least made of a micro-channel part which is associated with intermediary separation means; the micro-channel part includes an inlet which is used for the introduction of a sample-enriched mobile phase and an outlet at the terminal end of the micro-channel. In an embodiment, the device includes fluidics means which are designed for the capture of fractionation products and which are situated upstream from the evacuation outlet of the micro-column, capture micro-channels which are used to collect the captured fractionation products and groups of selective micro-cantilevers which are associated with the separation micro-columns and are situated downstream from the capture micro-channels; a micro-cantilever includes detection means which are associated with analytical means.

A fractionation micro-column refers to a part of a micro-channel which is fitted with separation means. The micro-channel part that forms the fractionation microcolumn can be connected with upstream or downstream micro-channel parts which are not fitted with separation means. In the following text, the inlet and the outlet of the fractionation micro-column refer to the respective ends of the micro-channel part which is designed as a fractionation micro-column. Separation means refer to the stationary phases which are used in chromatography or electrochromatography, or an electrophoresis gel, or electric means.

In chromatography, the stationary phase is called by opposition with the mobile phases which circulates in the micro-channel part. A mobile phase can advantageously be an eluent which, according to its composition, presents a more or less high affinity with sample constituents, such as small molecules or proteins, and, consequently, is more or less able to carry the constituents; a stationary phase tends to more or less slow down the migration of the constituents according to their characteristics.

A mobile phase circulates in a micro-channel thereby carrying a sample. The separation means which are fitted in the micro-channel part and thus constitute a fractionation micro-column, induce a fractionation or a separation of the sample constituents.

The separation is achieved through differential migrations of each constituent along the micro-column, according to the respective selectivity of the stationary phase and of the mobile phase. The mobile phase carries the constituents of the sample toward the evacuation outlet of the micro-channel.

The capture fluidic means allow to collect the constituents which are separated from the sample and which are located, at the time of the capture, in a small terminal part of the fractionation micro-column, the said terminal part being located upstream from the evacuation outlet of the micro-channel.

The captured constituents are carried in capture micro-channels toward selective micro-cantilevers, for their detection and their analysis. The combination of capture fluidic means and micro-cantilevers allows for a quick analysis of captured constituents in order to determine the composition of the sample. The analytical means associated with the micro-cantilevers allow for quick results.

In order to get a rapid and improved separation of the constituents of a sample, each separation micro-column, or each group of separation micro-columns of equal length, can have a different length from the others micro-columns or groups of micro-columns, the terminal elements being situated on each fractionation micro-column at a given distance from the terminal extremity of the fractionation micro-column. The sample-enriched mobile phase circulates from the introduction inlet of the micro-channel toward the evacuation outlet. The terminal elements, where captures are done, are situated at different distances from the introduction inlet of the micro-columns. The migration speed of constituents are different. Thus, at a given time after the migration starts, different constituents are present in the terminal elements of the micro-columns or groups of micro-columns. In the terminal elements of the longest micro-columns, the constituents which have migrated the fastest are present. In the terminal elements of the shortest micro-columns, the molecules which have migrated the slowest are present, the molecules which have migrated the fastest having been carried through the evacuation outlet by the circulating enriched mobile phase.

Preferably, each separation micro-column differs from the other by the same given element of length. This allows to assemble micro-columns as a gradient of lengths, thereby allowing a differential separation of the samples.

In order to improve the discrimination of captured constituents, the device includes secondary fractionation micro-columns which are located downstream from the capture fluidic means and upstream from the groups of micro-cantilevers which are associated with the fractionation micro-column; these secondary micro-columns can be used for a secondary fractionation of the captured constituents. Thus, the constituents which are captured in the terminal element, or a segment, of a primary micro-column are further separated before being analyzed with the micro-cantilevers, thereby resulting in a better detection.

In a embodiment, the device includes several groups of fractionation microcolumns; each group of fractionation micro-columns has a selectivity which is determined by the separation means of the fractionation micro-columns, including a stationay phase which is associated or not with electrical separation means. A separation of a sample in groups of micro-columns with different selectivities allows to reveal different constituents of the sample in each of the groups. The exhaustiveneness of the sample analysis is thus improved.

In an embodiment, the device includes a support with several groups of fractionation micro-columns, capture means and associated groups of micro-cantilevers, as well as a channel that is used to feed all of the groups of the fractionation micro-columns.

The selective micro-cantilevers include detection means which function according to the status of their surface or the status of their coated surface, their chemical nature or the chemical nature of their surface coating. Separated constituents, such as proteins, can react or not with one or several specific micro-cantilevers, which indicates their presence in the sample.

Preferably, micro-cantilevers include detection means that function by molecule adsorption.

Micro-cantilevers are designed to allow for the detection of molecules which are bound on them. Micro-cantilevers can be grafted with specific antibodies and thus can be used to detect the presence of a known molecule, such as a known protein which nature is already known. Micro-cantilevers which are designed to detect molecules which are adsorbed on them allow for the detection of molecules, and notably proteins, which nature is not previously known.

The comparison of adsorption patterns of proteins of several samples on micro-cantilevers allows to detect the proteins which are differentially expressed.

Preferably, micro-columns diameters will range between 10 microns (λtm) and 100 microns (λm).

In an embodiment, the device includes a fractionation support with fractionation micro-columns and a detection support with micro-cantilevers; both supports are approximately flat and can be laid out in an approximately parallel or perpendicular way.

In order to improve the discrimination between sample constituents, a preliminary fractionation tier can be added upstream from the fractionation microcolumuns; this tier includes at least one micro-column for preliminary fractionation, fludic capture means which are situated at the terminal end of the preliminary fractionation micro-column, and a collection channel which carries the preliminary extracts toward the fractionation micro-column. The preliminary extraction tier allows for an analysis of a sample fraction which contains a reduced number of constituents.

Preferably, the selectivity of the preliminary fractionation micro-columns is adjusted according to the selectivity of the associated fractionation micro-columns so as to favor the preliminary extraction of extracts that contains constituents which will be well separated in the associated fractionation micro-columns, taking into account their own selectivity.

Multiple preliminary extraction tiers which have different selectivities can be used, each preliminary extraction tier being associated with groups of fractionation micro-columns. In a preliminary extraction tier, successive peridocal captures can be used.

In an embodiment, a preliminary fractionation tier includes multiple preliminary fractionation micro-columns, each micro-column being intersected with a capture micro-channel and the capture micro-channels being associated with a collection channel.

In an embodiment, a preliminary fractionation tier includes multiple preliminary fractionation micro-columns, and a capture micro-channel is successively intersected with the preliminary fractionation micro-columns and is connected with a collection channel.

To improve the separation of sample constituents in a principal, secondary or preliminary fractionation micro-column, a terminal segment of the fractionation micro-column can be fitted with separation means which are different from those which are used in the intermediate separation means. The constituents that approximately arrive at the same time downstream from the fractionation micro-column present the same characteristics with respect to the selectivity of the intermediate separation means. A modification of the selectivity in the terminal section allows for the separation of these constituents.

In an embodiment, the fluidic capture means that are associated with a fractionation micro-column include a capture micro-channel with an upstream and a downstream segment; the upstream segment ends out into the downstream segment of a fractionation micro-column and the downstream segment emerges from an upstream segment of the fractionation micro-column. The shift between the upstream and downstream segments of a capture micro-channel allows for the capture of sample constituents that are located along a segment of a fractionation micro-column.

Such capture micro-channels with out-of-line sections can be planned for either a principal fractionation micro-columns or a preliminary extraction micro-columns, When used for a capture on a preliminary extraction micro-column, a larger diversity of molecules are captured. When used for a capture on a fractionation micro-column, the countercurrent circulation of a capture eluent in the capture segment can allow for a secondary fractionation of the fractionation product which is present in the capture segment at the time of capture.

In an embodiment, the analytical device comprises a selective microcantilevers washing micro-conduit which ends out in the capture micro-channel and upstream from the selective micro-cantilevers. A washing micro-conduit can be used to carry a washing buffer or an eluent directly on the micro-cantilevers. The micro-cantilevers retain some molecules according to their surface properties. A washing eluent is selected according to its affinity with the molecules which are retained on certain micro-cantilevers, so as to remove the molecules which are bound on these micro-cantilevers. A washing buffer can be used to remove all of the molecules which are bound on the micro-cantilevers.

The invention describes also a group of comparative chemical or biochemical analyses of at least two biological or chemical samples which include at least two devices that comprise multiple fractionation micro-columns for the separation of samples constituents; each fractionation micro-column includes a micro-channel with an inlet at one end which can be used for the introduction of a sample-enriched mobile phase, an outlet at the terminal end for fluid evacuation and intermediate separation means. A device also includes fluidic means for the capture of fractionation products that are located upstream from the evacuation outlet, capture micro-channels which can be used to collect the captured fractionation products, and groups of selective micro-cantilevers that are associated with the fractionation micro-columns and that are located downstream from the capture micro-channels, a micro-cantilever being fitted with detection means that are associated with analytical means. The system as a whole which includes separation and analytical means can be used for the rapid comparison of samples to determine the differences in composition of samples, which result, for example, from different physiological or pathological states of the cells contained in the samples.

The invention describes also an analytical chemistry or biochemistry process for chemical or biological samples in which differential fractionations are done on a sample-enriched mobile phase, the different fractionation products being simultaneously captured and the different fractionated constituents being analyzed with a group of selective micro-cantilevers. The differential fractionation results in a rapid separation of the sample constituents and a simultaneous capture of the fractionation products.

In order to improve a discrimination of the constituents during the analysis, the captured fractionation products are fractionated before analysis. The fractionation product includes some sample constituents. A supplementary separation or fractionation can be used to obtain constituents that are more separated, and thus that will be analyzed with a higher precision.

In an implementation mode, the constituents of a fractionation product are detected with micro-cantilevers according to characteristics of polarity, solvophobicity or porosity of the material that constitute the micro-cantilevers or of the coating material on the micro-cantilevers, or according to characteristics of polarity, solvophobicity, ion exchange or affinity with functional groups that are grafted on the micro-cantilevers.

The sample can be fractionated by chromatography, micro-electrophoresis or by interactions with nano-electrodes.

In an implementation mode, the flexion or the vibration frequency of micro-cantilevers is analyzed. A molecule, such as protein or a peptide can be bound on a micro-cantilever according to a selectivity which results, for example, from the status of a surface or from a coating.

The flexion of a micro-cantilever that is induced by adsorbtion of a molecule can be measured. The micro-cantilever can also be excited in vibration at some frequencies, for exempale its frequency resonance. When a protein is bound to a micro-cantilever, the modification of the vibration frequency is measured.

In an implementation mode, the fractionationed constituents are analyzed by mass spectrometry, before or after the analysis with the micro-cantilevers.

To compare a sample with a reference sample, the first sample is analyzed, the second sample is analyzed and the analytical results of both samples are compared. In this case, the first and the second samples are analyzed with the intent to compare the samples proteins binding patterns by using selective micro-cantilevers which can be used to reveal a differential binding pattern. In other words, the samples are analyzed by using micro-cantilevers which are adjusted so as to be able to detect differences in sample compositions, taking into account the differential status of micro-cantilevers and the difference in composition which is expected.

Advantageously, a preliminary extraction is done on a sample before a differential fractionation of the sample.

The present invention and its advantages are better understood by studying the detailed descriptions of the embodiments which are non limitating examples and illustrated by the drawings in appendix on which:

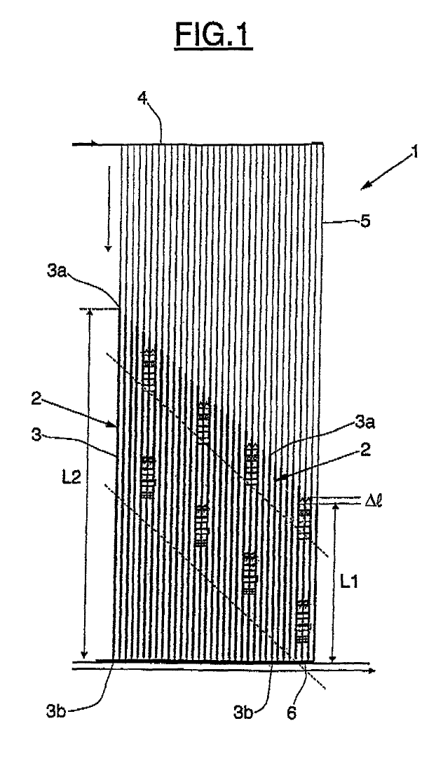

FIG. 1 is a partial schematic view of an analytical device which includes micro-columns according to an embodiment of the invention;

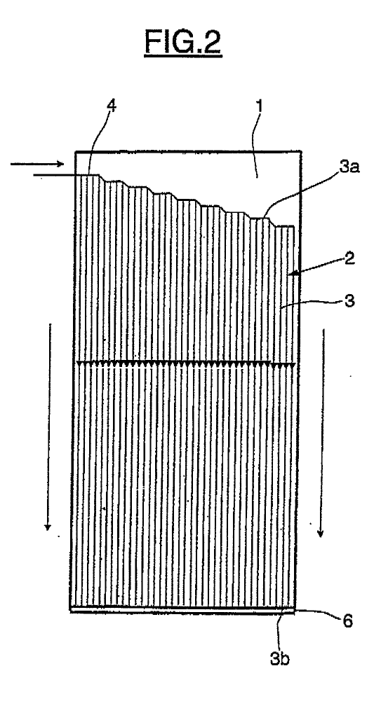

FIG. 2 is a schematic view of a first variant of the analytical device described in FIG. 1;

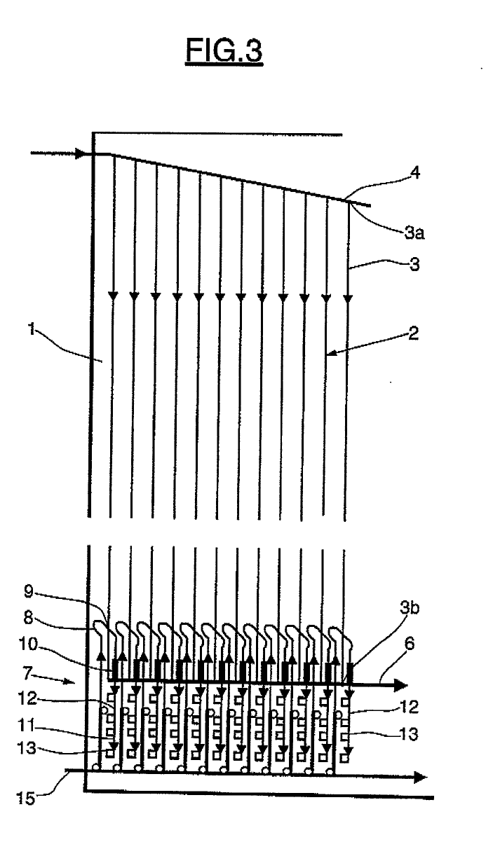

FIG. 3 is a schematic view of a second variant of the device described in FIG. 1 where fluidic means for capture are figured according to one embodiment of the invention;

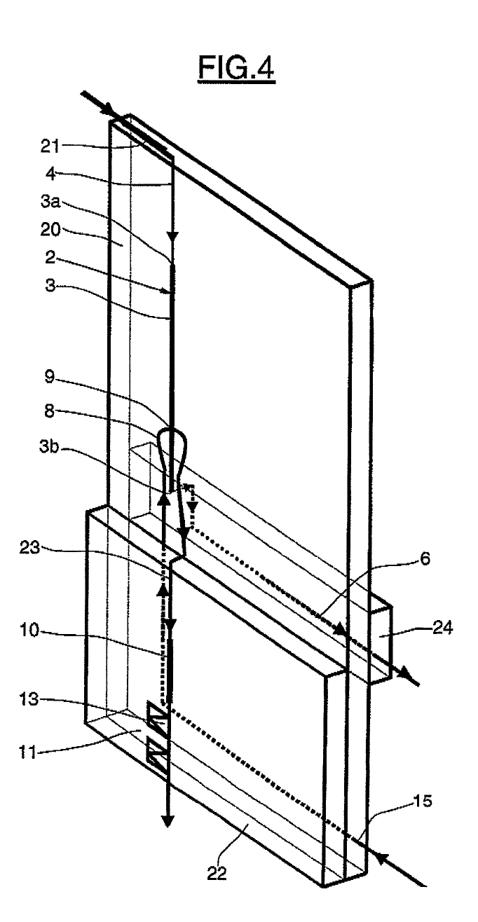

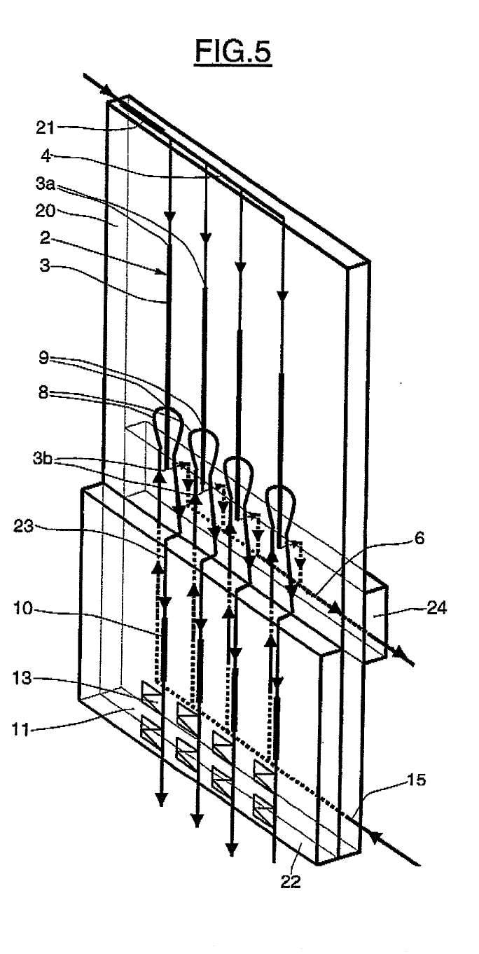

FIGS. 4 and 5 are partial schematic views of an analytical device that displays a specific design of the supports;

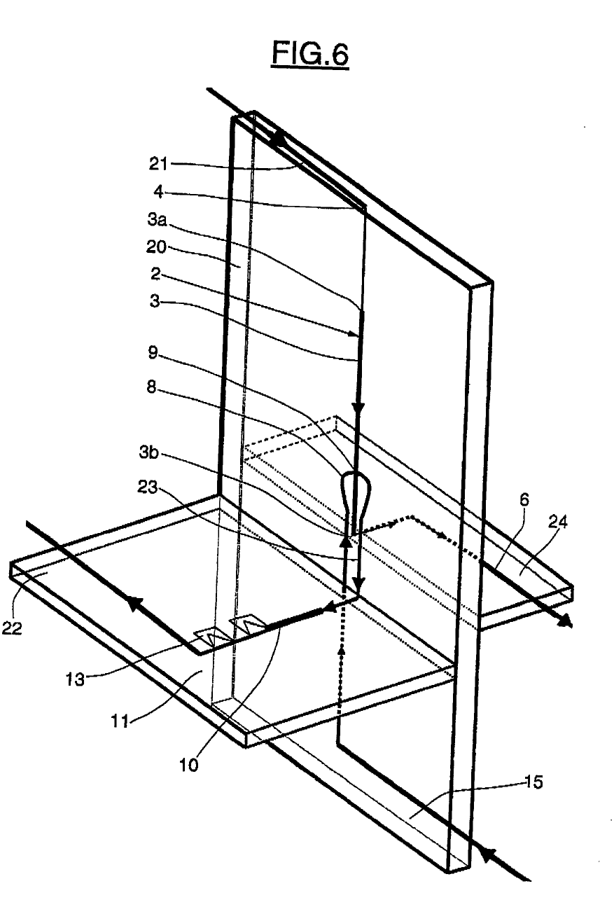

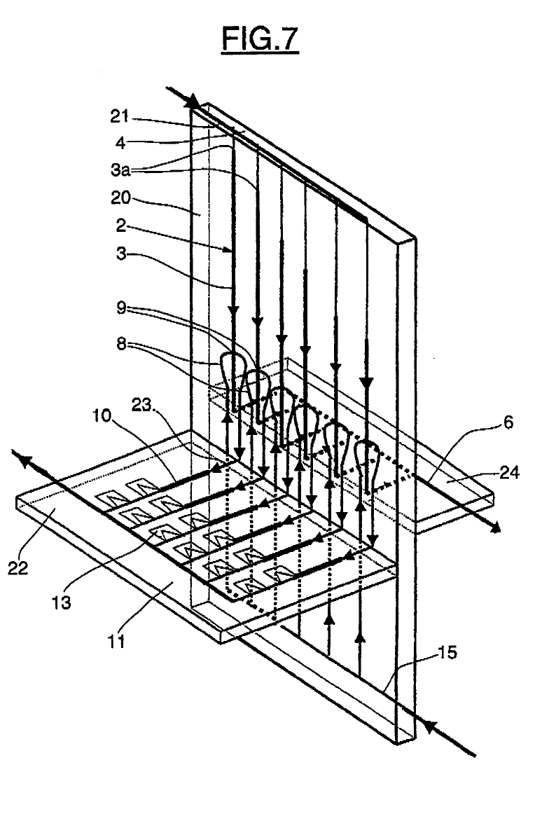

FIGS. 6 and 7 are partial schematic views of an analytical device that displays another design of the supports;

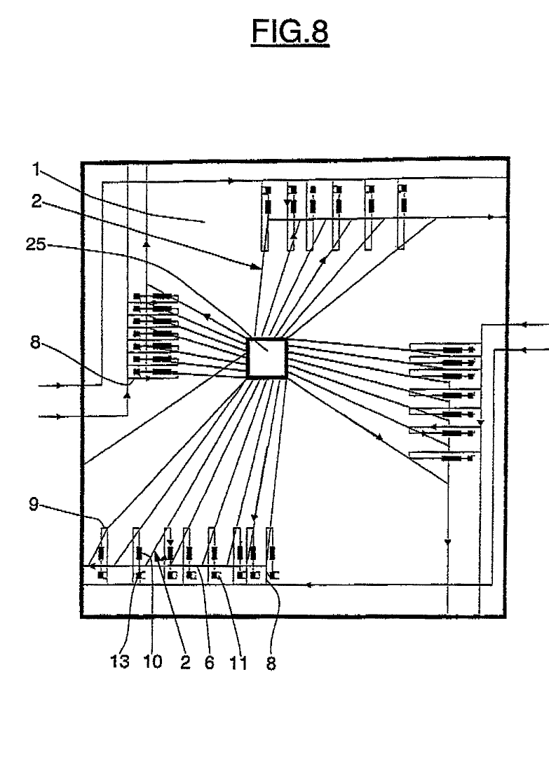

FIG. 8 is a schematic view of the whole device according to one embodiment of the invention;

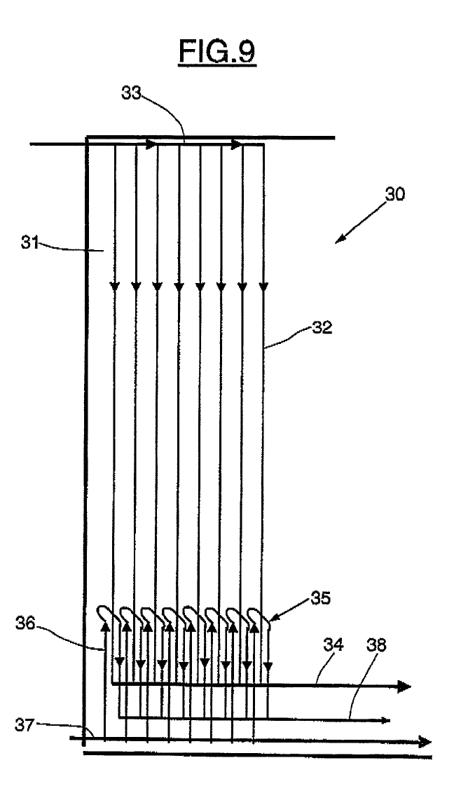

FIG. 9 is a partial schematic view of a preliminary extraction tier of a support;

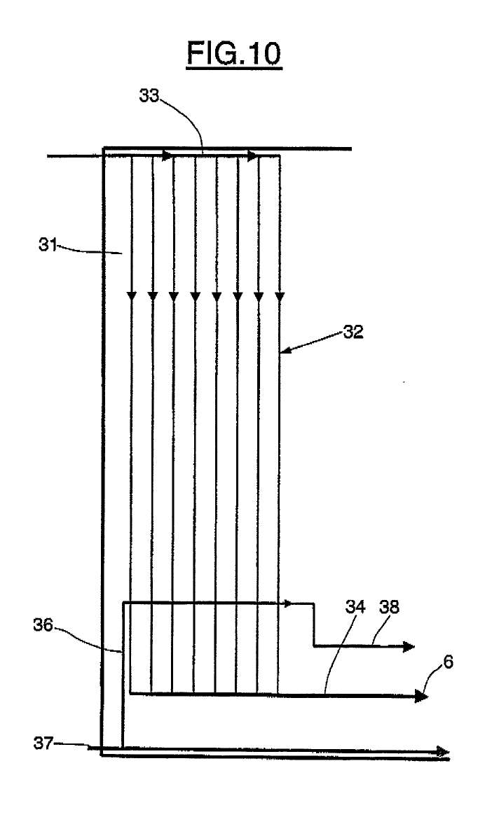

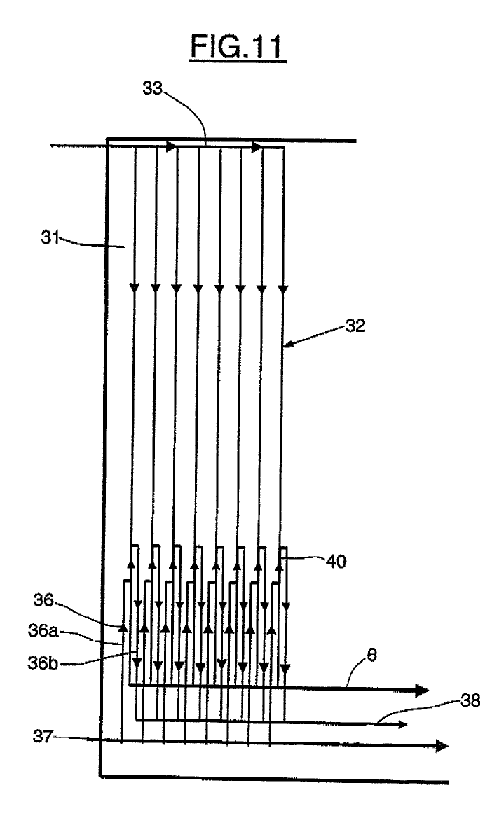

FIGS. 10 and 11 are partial schematic views of variants of the preliminary extraction tier as described in FIG. 9;

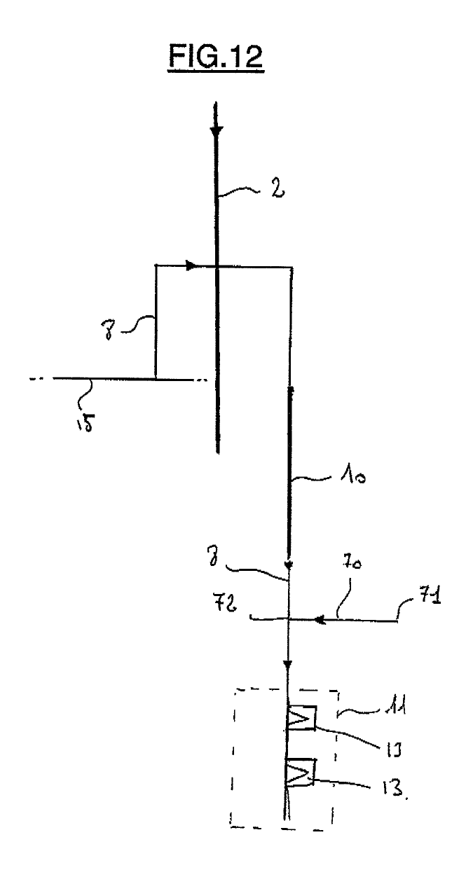

FIG. 12 is a schematic view of a micro-cantilever washing circuit;

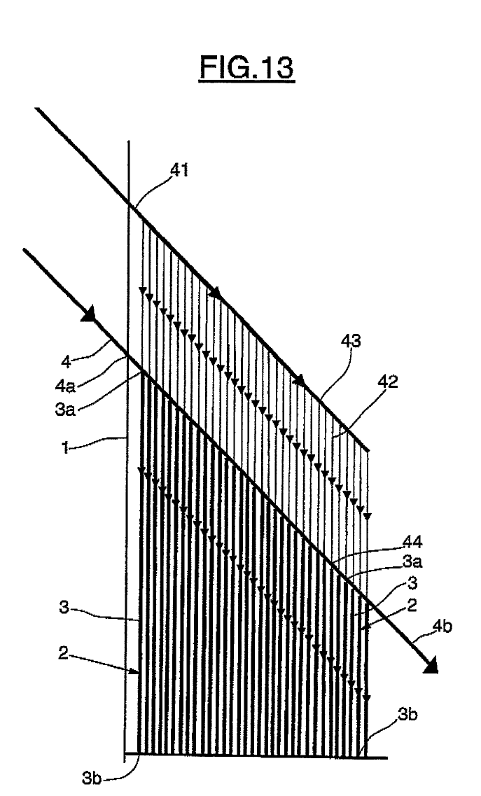

FIG. 13 is a partial schematic view of an analytical device with separated mobile phase and sample feeding micro-channels;

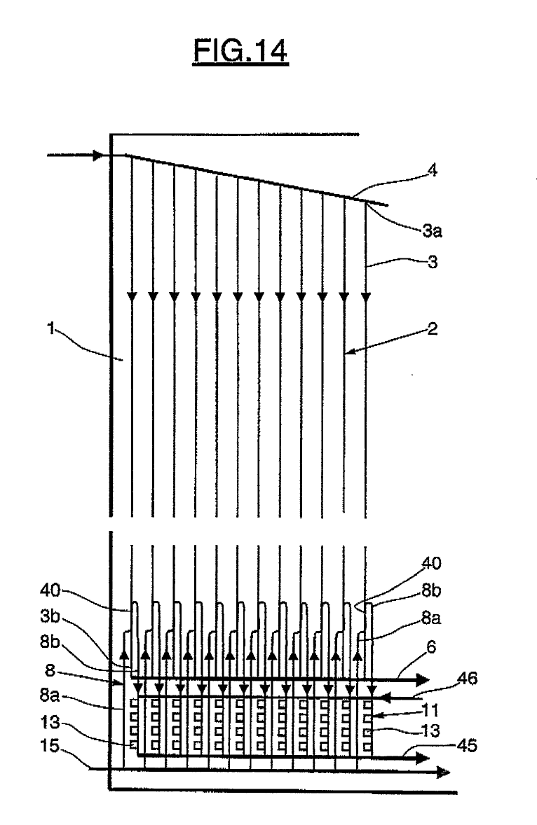

FIG. 14 is a variant of a device which is shown on FIG. 3.

On FIG. 1, a support 1 includes multiple micro-columns 2 that are laid out in parallel and form a gradient of lengths. The micro-columns 2 are figured as bold lines.

Each micro-column 2 includes a micro-channel 3 with an introduction inlet 3a and an evacuation outlet 3b. Each segment of micro-channel 3 is fitted with intermediate separation means. A feeder channel 4 is connected with all of the introduction inlets 3a of the micro-columns 2. The feeder channel 4 is connected to the introduction inlet 3a of the fractionation micro-columns 2 with intermediary channels 5 that are displayed with thin lines in order to differentiate them from the fractionation micro-columns 2. The intermediate micro-channels 5 are actually micro-channel segments that are not fitted with separation means and are situated upstream from the micro-channels 3 that form the fractionation micro-columns 2. An evacuation channel 6 is connected to all of the evacuation outlets 3b of the micro-columns 2.

The segments of the micro-channels 3 that form the fractionation microcolumns 2 have different lengths, each micro-channel 3 is different from the next microchannel 3 by a specific element of length delta 1. The micro-channels 3 display a gradient of lengths. The length of the shortest micro-column 2 is L1. The length of the longest micro-column 2 is L2.

As a non limitating example, the length L2 of the shortest fractionation micro-columns 2 range between 1 and 20 centimeters. As a non limitating example, the length L1 of the longest fractionation micro-columns 2 range between 5 and 40 centimeters. The said fractionation micro-columns 2 have a diameters which ranges between 1 and 100 microns, and notably between 10 and 100 microns. As a non limitating example, the difference in length between a fractionation micro-column 2 and another fractionation micro-column 2 which is immediately longer, ranges between 1 and 100 microns.

On FIG. 2, the references to the elements are the same as those used in FIG. 1. An integrated support 1 is equipped with fractionation micro-columns 2. The micro-columns 2 of a same group have the same length. The micro-columns 2 of a group differ in length from the micro-columns 2 of another group. More precisely, the fractionation micro-columns 2 of one group differ from the micro-columns 2 of another group by a very small element of length. In other words, groups of micro-columns 2 are assembled to form a gradient of lengths.

As displayed on FIG. 2, a feeder channel 4 is directly connected to the introduction inlets 3a of the fractionation micro-columns 2 and is not associated with intermediate micro-channels.

Micro-channels 3 are entirely configured as fractionation micro-columns 2, and are fitted all along with separation means.

On FIG. 3, where the references to the elements are similar to those used on FIG. 1, a support 1 includes fractionation micro-columns 2 and capture fluidic means 7. The introduction inlets 3a are connected directly to the feeder channel 4. The fractionation micro-columns 2 are assembled to form a gradient of lengths.

The capture fluidic means 7 include capture micro-channels 8 which are intersected with fractionation micro-channels 3 at the level of a terminal element or a terminal segment 9 of each fractionation micro-channel 3, at a specific distance from the terminal end of the micro- channels 3, i.e. at a specific distance from its evacuation outlet 3b. Each fractionation micro-channel 3 is connected with a capture micro-channel 8. The introduction inlets of the capture micro-channels 8, which are located upstream from the intersection with the fractionation micro-channels 3, are connected with a secondary feeder channel 15 that can be used to feed the system with a secondary mobile phase.

The support 1 also includes secondary fractionation micro-columns 10 which are located downstream from the capture micro-channels 8 and upstream from the detection zones 11. A secondary fractionation micro-column 10 is connected with a capture micro-channel 8 and a detection zone 11. A secondary fractionation microcolumn 10 includes fractionation means which are similar to those included in the fractionation micro-column 2 to which it is connected. A detection zone 11 includes a circulation channel 12 associated with one or several selective micro-cantilevers 13.

To conduct a sample analysis, a sample-enriched mobile phase, preferably under the form of an eluent, is carried by the feeder channel 4 toward all of the fractionation micro-columns 2 through their introduction inlets 3a. The sample-enriched mobile phase circulates from the introduction inlet 3a toward the evacuation outlet 3b and is separated by the fractionation micro-channel 3. The terminal elements 9, where captures are conducted, are located at different distances from the introduction inlets 3a of the fractionation micro-columns 2. The migration speeds of the constituents are different. Thus, at a given time after the migration starts, there are different groups of constituents in the terminal elements 9 of the micro-column 2. The constituents that migrate fastly will be present in the terminal elements 9 of the longest fractionation micro-columns 2. At the same time, the constituents that migrate slowly will be present in the terminal elements 9 of the shortest fractionation micro-columns 2. The molecules which migrate through the terminal elements 9 are evacuated through the evacuation outlet 3b and the evacuation channel 6.

It should be noted that the migration speeds of the constituents and thus, the separation, depend on the selectivity of the separation means of a micro-column, and on the nature of the mobile phase or the eluent which carries the sample constituents. The separation means tend to more or less retain the constituents according to their characteristics, whereas the eluent tends to carry the constituents according to their characteristics too.

To capture the separated constituents of the sample, a micro or nano-flux of secondary eluent is circulated simultaneously in all of the capture micro-channels 8. A nano-flux of secondary eluent which circulates in a capture micro-channel 8 flows through the terminal element of length Delta L which is contained in the associated micro-channel 3.

The nano-flux of secondary eluent is collected in a downstream segment of the capture micro-channel 8 after its migration through the terminal element. The sample constituents which are present in the terminal element at the time of capture are carried into the capture micro-channel 8. Preferably, on choose a secondary eluent which is able to carry along the constituents which are retained in the fractionation micro-column 2.

The captured constituents are then defined as fractionation products. A fractionation product includes multiple constituents of the sample. A fractionation product are notably separated molecules, molecular complexes that are not separated and molecular aggregates that are not disaggregated.

The fractionation products are carried through the capture micro-channels 8 toward the secondary fractionation micro-columns 10. When flowing through these secondary fractionation micro-columns 10, the fractionation products are further separated. In the secondary fractionation micro-columns 10, the fractionation products can undergo micro or nano-extraction, or secondary, terminal, parallel or simultaneous separations, and/or enzymatic, terminal, parallel, simultaneous micro or nano-digestions.

The products which result from secondary micro or nano-elution, secondary micro or nano-digestion and secondary micro or nano-extraction—then called secondary fractionation products—circulate through the capture micro-channels 8 downstream from the secondary fractionation micro-columns 10, toward the detection zone 11. The detection of the constituents that are present in the secondary fractionation products is made with the selective micro-cantilevers 13.

The retention of the constituents, that are present in the secondary fractionation products, on the micro-cantilevers 13 is measured by measuring the flexion of the micro-cantilevers 13 or by measuring the variation of the vibration frequency of the micro-cantilevers 13.

The fractionation means of the secondary fractionation micro-columns 10 are similar to those of the fractionation micro-columns 2. However, the fractionation means of the secondary fractionation micro-columns 10 are can be different from those of the associated fractionation micro-columns 2. Notably, the selectivity of the fractionation means can be different in order to favor the separation of the constituents which are present in the fractionation product. These constituents, that were captured simultaneously in the same fractionation product after a first fractionation, have similar migration characteristics which result from the selectivity of the fractionation micro-columns from which they come. A second separation with a different selectivity results in an efficacious secondary separation. Obviously, the secondary eluent is selected in order to favor this secondary separation.

A group of fractionation micro-columns 2 with similar fractionation means can be used. Various groups of fractionation micro-columns 2 can also be used, each group including fractionation micro-columns 2 with specific fractionation means with, for example, different types of selectivity. Thus, according to the selectivity of a group of fractionation micro-columns 2, a specific constituent is better separated in this group and can be detected more easily downstream from this group.

In the case of multiple groups of fractionation micro-columns 2, the fractionation micro-columns 2 can be fed from a single enrichment column, i.e. a channel that feeds the fractionation micro-column with an enriched mobile phase, or from multiple enrichment columns, a specific group being associated with a specific enrichment column where a specific eluent is circulated and is selected according to the specific separations means of the group of fractionation micro-columns 2. Indeed, the migration speeds of the constituents differ from each other according to the type of selectivity of the fractionation micro-columns and the nature of the eluent.

Obviously, the fractionation micro-columns or groups of fractionation micro-columns can be assembled to form gradients of lengths.

A fractionation of a sample followed by the capture of fractionation products and by the detection of their constituents can be used to collect a “pattern” of the sample. Series of patterns can be generated. In order to achieve successive captures and detections with the same detection micro-cantilevers, on can foresee successive washing steps of the micro-cantilevers 13, notably with eluents which are able to carry along the molecules that are retained on the micro-cantilevers.

A separation of the sample constituents can be performed according to an isocratic mode, or a step by step elution mode, or according an elution gradient mode, i.e. according to a progressive and continuous variation of an eluent composition.

The molecules which are carried by a mobile phase in the fractionation micro-columns 2 are retained according to the selectivity of separation means of the fractionation micro-columns 2. The flow of an eluent with a particular composition and thus with a particular affinity for some molecules can be used to preferentially carry these molecules, the other molecules being retained by the separation means of the stationary phase.

The sample constituents are separated according to their migration speed, which depends on their characteristics, on the selectivity of the separation means, and on their affinity with a mobile phase.

A variation in the composition of an eluent results in the migration of different constituents and thus an improved separation. The variation in the composition can be achieved either by successive steps, or in a continuous way. In that case, it is called a gradient of eluents.

The capture of fractionation products is done by using a step-by-step mode, each capture step being based on a precise physical or chemical or hydrodynamic condition that prevails at the intersection of the fractionation micro-column 2 with the said capture micro-channel 10.

Series of patterns from two samples can be compared. The successive series of patterns of a first sample are compared with the successive series of patterns of a second sample using analytical means such as informatics; the series of patterns can be then archived in a computerized database.

Let's consider an analytical device according to one embodiment of the invention, which includes two groups of (x) supports, each being equipped with (z) groups of (t) fractionation micro-columns.

For each sample, a step-by-step elution can be done with (n) steps of primary elution in (t) fractionation micro-columns 2. For each primary elution step, secondary step-by-step micro or nano-elution with (m) elution steps can be done.

At the end, the analytical process of the sample generates, for each group of supports, the flow of (n * m * t * z * x) fractionation products on the detection zones (* is the sign for multiplication).

As a non restrictive example, (n) ranges between 1 and 5, (m) ranges between 1 and 5, (x) ranges 5 and 50, (z) ranges between 1 and 5, and (t) ranges between 10 and 10 000, notably between 10 and 1000.

A group of support is used to analyze a sample, another group of support is simultaneously used to analyze another sample. The pattern made of (n * m * t * z * x) detections of the first sample is compared with the pattern made of (n * m * t * z * x) detections of the second sample.

Alternatively, the primary and secondary elutions are conducted by using elution gradients. In this case, multiple successive patterns on micro-cantilevers are generated at various or fixed time intervals. Between each pattern, the micro-cantilevers can be washed.

If the number of generated patterns is (p), thus, at the end, the whole analytical process of the sample provides, for each group of supports, (p * t * z * x) fractionation product detections in the detection zones.

As a non limitating example, the separation in the fractionation microcolumns 2 or the secondary fractionation micro-columns 10 can be done by electrophoresis, chromatography or electrochromatography.

Separation methods by chromatography or electrophoresis were described in the following article (Veraart J R, Lingeman H, Brinkman U A T. Coupling of biological sample handling and capillary electrophoresis. Journal of Chromatography A, 1999, 856, 483-514).

Separation methods for peptides and proteins can be used, including hydrophobic protein which were described in the following articles (Herraiz T, Casal V. Evaluation of solid-phase extraction procedures in peptide analysis. Journal of Chromatography A, 1995, 708, 209, 221; Schweitz L, Petersson M, Johansson T, Nilsson S. Alternative methods providing enhanced sensitivity ansd selectivity in capillary electro-separation experiments. Journal of Chromatography A, 2000, 892, 203-217; Bosserhoff A, Wallach J, Frank R W. Micropreparative separation of peptides derived from sodium dodecyl sulphate-solubilized proteins. J. Chromatogr, 1989, 473(1).71-77; Huang J X, Guiochon G. Applications of preparative high-performance liquid chromatography to the separation and purification of peptides and proteins. J chromatography 1989, 492, 431-69; Rivasseau C, Vanhoenacker G, Sandra P, Hennion MC. On-line solid-phase extraction in Microcolumn-Liquid Chromatography coupled to UV or MS detection: application to the analysis of cyanobacterial toxins. J. Microcolumn separations, 2000, 12(5), 323-332; Kutter J P, Jacobson S C, Ramsey J M. Solid phase extraction on micro-fluidic devices. J. Microcolumn Separations, 2000, 12(2),93-97.).

Separation methods for membrane proteins can be used, such as those which are described in the following articles (Santoni V, Kieffer S, Desclaux D, Masson F, Rabilloud T. Membrane Proteomics: use of additive main effects with multiplicative interaction model to classify plasma membrane proteins according to their solubility and electrophoretic properties. Electrophoresis 2000, 21 (16), 3329-44; Santoni V, Doumas P, Rouquie D, Mansion M, Rabilloud T, Rossignol M. large scale characterization of plant plasma membrane proteins. Biochimie 1999, 81(6), 655-61; Thomas T C, Mac Namee M G. Purification of membrane proteins. Methods in Enzymology. Vol 182, 499-520; Power S D, Lochrie M A, Poyton R O. Reversed-phase high performance liquid chromatographic purification of subunits of oligomeric membrane proteins. The nuclear coded subunits of yeast cytochrome c oxidase. J Chromatogr, 1983, 266, 585-98; Josic D, Hofmann W, Habermann R, Becker A, Reuter W. High performance liquid affinity chromatography of liver plasma membrane proteins. J. of Chromatography A, 1987, 397, 39-46.; Lee R P, Doughty S W, Ashman K, Walker J. Purification of hydrophobic integral membrane proteins from mycoplasma hyopneumoniae by reversed-phase high performance liquid chromatography. Journal of Chromatography A, 1996, 737, 273-279; Sivars U, Tjemeld F. Mechanisms of phase behaviour and protein partitioning in detergent/polymer aqueous two-phase systems for purification of integral membrane proteins. Biochimica et Biophysica Acta, 2000, 1474, 133-146; Ferro M, SeigneurinBemy D, Rolland N, Chapel A, Salvi D, Garin J, Joyard J. Organic solvent extraction as a versatile procedure to identify hydrophobic chloroplast membrane proteins. Electrophoresis 2000, 21, 3517-3526; Stark M, Jornvall H, Johansson J. Isolation and characterization of hydrophobic polypeptides in human bile. Eur J Biochem 1999, 266(1), 209-14.)

The purification of very hydrophobic peptides can be achieved with organic solvents such as a mixture of dichloromethane-hexafluoro-2-propanol with traces of pyridine and a linear gradient of formic acid-2-propanol and formic acid-water on a non-polar stationary phase such as Vydac C4 (Bollhagen R, Schmiedberger M, Grell E. High performance liquid chromatographic purification of extremely hydrophobic peptides: transmembrane segments. Journal of Chromatography A, 1995, 711, 181-186.)

Non aqueous solvents can also be used, such as those described in the following article which were used in combination with non aqueous capillary electrophoresis separation methods (Cottet H, Struijk M P, Van Dongen J L J, Claessens H A, Cramers C A. Non-aqueous capillary electrophoresis using non-dissociating solvents. Application to the separation of highly hydrophobic oligomers. Journal of Chromatography A, 2001, 915, 241-252;Veraart, J. R., Reinders, M. C., Lingeman, H. and Brinkman U. A. Non-aqueous capillary electrophoresis of biological samples after at-line solid-phase extraction. J. Chromatogr. A 811 (1998) 211-217; Yang, Q., Benson, L. M., Johnson, K. L. and Naylor, S. Analysis of lipophilic peptides and therapeutic drugs: on-line-nonaqueous capillary electrophoresis-mass spectrometry. J. Biochem. Biophys. Methods 38 (1999) 103-121; Belder, D., Elke, K. and Husmann, H. Use of coated capillaries for nonaqueous capillary electrophoresis. J. Microcol. Sep. 11 (1999) 209-213; Lister, A. S., Dorsey, J. G. and Burton, D. E. Current measurement of nonaqueous solvents: applications to capillary electrophoresis and electrochromatography. J. High Res. Chromatogr. 20 (1997) 523-528; Belder, D., Husmann, H. and Warnke, Directed control of electroosmotic flow in nonaqueous electrolytes using poly ethylene glycol coated capillaries. J. Electrophoresis 22 (2001) 666-672; Bjømsdottir, I. and Hansen, S. H. Comparison of separation selectivity in aqueous and non-aqueous capillary electrophoresis. J. Chromatogr. A 711 (1995) 313-322; Walbroehl, Y. and Jorgenson, J. W. Capillary zone electrophoresis of neutral organic molecules by solvophobic association with tetraalkylammonium ion. Anal. Chem. 58 (1986) 479-481; Wei, H. and Li, S. F. Y. Nonaqueous capillary zone electrophoresis for separation of free fatty acids with indirect fluorescence detection. Electrophoresis 19 (1998) 2187-2192; Raith, K., Wolf, R., Wagner, J. and Neubert, R. H. H. Separation of phospholipids by nonaqueous capillary electrophoresis with electrospray ionization mass spectrometry. J. Microcol. Sep. 10 (1998) 681-685 Drange, E. and Lundanes, E. Determination of long-chained fatty acids using nonaqueous capillary electrophoresis and indirect UV detection. J. Chromatogr. A 771 (1997) 301-309; Esaka, Y., Yoshimura, K., Goto, M. and Kano, K. Non-aqueous capillary zone electrophoresis using polyethylene glycol as a matrix agent. J. Chromatogr. A 822 (1998) 107-115; Jansson, M. and Roeraade. [N-Methylformamide as a separation medium in capillary electrophoresis. J. Chromatographia 40 (1995) 163-169; Esaka, Y., Inagaki, S., Uchida, D., Goto, M. and Kano, K. Polyacrylamides as hydrophilic selectors in non-aqueous capillary electrophoresis. J. Chromatogr. A 905 (2001) 291-297; Hansen, S. H., Tjørnelund, J. and Bjømsdottir, I. Selectivity enhancement in capillary electrophoresis using non-aqueous media. Trends Anal. Chem. 15 (1996) 175-180; Jussila, M., Sundberg, S., Hopia, A., Makinen, M. and Riekkola, M.-L. Separation of linoleic acid oxidation products by micellar electrokinetic capillary chromatography and nonaqueous capillary electrophoresis. Electrophoresis 20 (1999) 111-117; Jussila, M., Sinervo, K., Porras, S. P. and Riekkola, M.-L. Modified liquid junction interface for nonaqueous capillary electrophoresis-mass spectrometry. Electrophoresis 21 (2000) 3311-3317; Koch, J. T., Beam, B., Phillips, K. S. and Wheeler, J. F. Hydrophobic interaction electrokinetic chromatography for the separation of polycyclic aromatic hydrocarbons using non-aqueous matrices. J. Chromatogr. A 914 (2001) 223-231; Li, S. and Weber, S. G. Separation of neutral compounds in nonaqueous solvents by capillary zone electrophoresis. J. Am. Chem. Soc. 122 (2000) 3787-3788; Miller, J. L., Khaledi, M. G. and Shea, D. Separation of hydrophobic solutes by nonaqueous capillary electrophoresis through dipolar and charge-transfer interactions with pyrylium salts. J. Microcol. Sep. 10 (1998) 681-685; Riekkola, M.-L., Wiedmer, S. K., Valkó, I. E. and Sirén, H. Selectivity in capillary electrophoresis in the presence of micelles, chiral selectors and non-aqueous media. J. Chromatogr. A 792 (1997) 13-35; Riekkola, M.-L., Jussila, M., Porras, S. P. and Valkó, I. E. Non-aqueous capillary electrophoresis. J. Chromatogr. A 892 (2000) 155-170; Sahota, R. S. and Khaledi, M. G. Nonaqueous capillary electrophoresis. Anal. Chem. 66 (1994) 1141-1146; Steiner, F. and Hassel, M. Nonaqueous capillary electrophoresis: A versatile completion of electrophoretic separation techniques. Electrophoresis 21 (2000) 3994-4016; Tjørnelund, J., Bazzanella, A., Lochmann, H. and Bächmann, K. Coelectroosmotic separations of anions in non-aqueous capillary electrophoresis. J. Chromatogr. A 811 (1998) 211-217; Wang, T., Ward, V. L. and Khaledi, M. G. Efficiency studies in nonaqueous capillary electrophoresis. J. Chromatogr. A 859 (1999) 203-219; Wright, P. B., Lister, A. S. and Dorsey, J. G. Behavior and use of nonaqueous media without supporting electrolyte in capillary electrophoresis and capillary electrochromatography. Anal. Chem. 69 (1997) 3251-3259).

Zwitterionic surfactants can be used, such as C9-APSO4 3 or C10-APSO4, (nonyl-dimethyl-ammonio) propyl sulfate and (3-(decyl -dimethyl-ammonio) propyl sulfate), respectively, for the extraction and pre-concentration of hydrophobic molecules (Saitoh T, Hinze W L. Concentration of hydrophobic organic compounds and extraction of proteins using alkylammoniosulfate zwitterionic surfactant mediated phase separations. Anal. Chem 1991, 63(21), 2520-5.)

By using the balance between the sulfur and nitrogen atoms which garantee the strong zwitterionic character of a stationary phase which is made of macro-porous monoliths synthesized in situ by photopolymerization and which contains copolymers made with sulfoalkylbetain (N,N-dimethyl-N-methacryloyloxyethyl-N-(3-sulfopropyl) ammonium betain), basic proteins can be extracted by chromtographic interactions and elutions with low ionic forces solutions which were modified with chaotropic ions such as perchlorate and thiocyanate (Viklund C, Sjorgen A, Irgum K, Nes I. Anal. Chem. Feb. 1, 2001. 73,(3), 444-52.)

Basic analytes can also be separated by combination with non-aqueous capillary electrophoresis (Karbaum, A. and Jira, Th. Nonaqueous capillary electrophoresis: Application possibilities and suitability of various solvents for the separation of basic analytes. Electrophoresis, 1999, 20, 3396-3401.)

For the separation of hydrophobic proteins, chromatography by size exclusion can also be used with apolar stationary phases and elutions with a ternary mixture such as (chloroforme-methanol-acide trifluoro-acetique) (Bunger H, Kaufner L, Pison U. Quantitative analysis of hydrophobic pulmonary surfactant proteins by high performance liquid chromatography with light-scattering detection. J. Chromatogr A, 2000, 18, 870(1-2), 363-9.)

A micellar retro-extraction method can be used, i.e. a method in which the proteins which are encapsulated in micelles are recovered after micelles destruction by a surfactant which has a counter-electrostatic action (Jarudilokkul S, Poppenborg L H, Stuckey D C. Backward extraction of reverse micellar encapsulated proteins using a counterionic surfactant. Biotechnol. Bioeng. 1999, 62(5), 593-601.)

Glycoproteins can be purified by affinity chromatography with lectins as described in the following article (Gerard G, Purification of glycoproteins. Methods in Enzymology, vol 182, 529-539.)

Multi-enzymes complex can also be purified as described in the following artcile (Srere P A, Matthews C K. Purification of Multienzyme Complexes. Methods in Enzymology, vol 182, 539-551).

Extraction and chromtatography are based, in particular, on the notion of polarity which results from an asymetrical repartition of electrons clouds within molecules.

The polarity scales are conceived by different independent methods which result from different consequences of polarity phenomenons:

The first method measures the free energy of adsorption by surface unit of a solvent (which a specific polarity) to a solid phase (which has another specific polarity). For example, when the adsorption on alumine is measured, this method provides the following order: water>methanol>ethanol>2-propanol>dimethylsulfoxyde>acetonitrile>methylethylketone.

The second method (Rohrschneider) experimentally measures distribution coefficient of test solutions between several phases. For example, this method provides the following order of polarity:water>dimethylsulfoxyde >acetonitrile>methanol>methylethylketone>ethanol>2-propanol.

In the Rohrschneider global polarity, the share of partial polarities can be determined, i.e. the power to accept protons, the power to give protons and the power to create dipole-dipole interactions, respectively. Alcohols are mainly protons acceptors, acetonitrile and methyl-ethyl-cetone have mainly a power to create dipole-dipole interactions and dimethylsulfoxide has an equal power to accept protons and create dipole-dipole interactions.

The third method (Hildebrand and Scott) defines solubility parameters which are calculated from the molecular cohesion energy resulting from all the intermolecular interactions of a solvent, this energy being calculated from the molecular enthalpy of vaporisation. For example, this method provides the following order of polarity:water>methanol>ethanol>dimethylsulfoxyde>acetonitrile>2-propanol>methylethylketone.

Repartition chromatography is based on the differential solubility of analytes between two liquid phases, and more precisely between a mobile liquid phase and another liquid phase, said to be stationary, located wihthin a porous solid phase made of small particles.

The solid phase can be polar, and made of, for example, particles of silica gel which are grafted with aminopropyl, paranitrobenzyl, alkylnitril or glyceropropyl groups. In this case, the weakly polar mobile phase such as a 95% hexane /5% dichloromethane mixture will be added with a “polar modifier” to produce a mixture with a higher polarity (such as 80% hexane, 20% dichloromethane) until it can displace polar analytes which interact with the stationary polar liquid phase. This is called repartition chromatography in normal phase.

The solid phase can also be apolar, such as styrene-divinylbenzene copolymers matrices, or pyrocarbon, matrices or silica gels which are grafted with apolar functional groups (for example alkyls or phenyls). In this case, the polar mobile phase (such as a 40% methanol or acetonitrile, 60% water mixture) will be added with a “polar modifier” to produce a solution with a lesser polarity (60% methanol or acetonitrile, 40% water), until it can displace the apolar analytes which interact with the apolar liquid stationary phase. This is called reverse phase repartition chromatography.

The other chromatography techniques for separation are based on a differential retention of the analytes contained in a mobile, liquid or gaseous, phase which migrates through a solide stationary phase. According to the method which is used, the retention mode is based on the size, the adsorption or the affinity.

The size exclusion chromtagraphy is based on a stationary phase made of porous particles that form a gel. The distribution range of pore diameters within the porous particles is wide. According to their steric dimensions, molecules can or cannot migrate through a more or less high number of porous particles. Those that migrate the most easily through the pores of the porous particles are those which are the most delayed. Practically, the phenomenon is biased by the ionic or hydrophobic interactions between the analytes and the stationary phases. Moreover, parasite effects—such as those caused by a turbulent flow of the mobile phase or such as those of a gravitational effect which is due to density differences between the mobile phase and the solutions have led to perfom this type of chromatography with very small size particles and with middle to high pressure. Size exclusion chromatography is a soft technique where molecules can stay in any medium with any degrees of ionic forces or with any pH, with any degrees in detergents or chaotropic agents or any kinds of solution that is appropriate to maintain their integrity. Fore example, proteins which are separated by this mean can keep their functional or structural stability because the mobile phase can accept ions and cofactors that favor it.

Size exclusion chromatography in denaturing or non denaturing conditions can also help, while minimizing the use of detergents, the characterization of molecular aggregates where membrane proteins are included (Loster K, Baum O, Hofman W, Reutter W. Characterization of molecular aggregates of alphal betal integrin and other rat liver membrane proteins by combination of size exclusion chromatography and chemical cross-linking. Journal of Chromatography A, 1995, 711, 187-199.) Preferentially used chromatography techniques are those that are based on a differential adsorption of the analytes which are contained in a mobile, liquid or gaseous, phase which migrates through a solid stationary phase. The selectivity in adsorption chromatography, as well as in other chromatography techniques, is based upon a complete process for each analyte: carrying by the mobile phase and energy specific interaction with the stationary phase. The polarity of the analyte stands between that of the mobile phase and that of the stationary phase. If the polarity of the analyte is too far from that of the mobile phase, the solubility of the analyte in the mobile phase will not be sufficient to prevent an irreversible retention by the stationary phase. If the polarity of the analyte is too different from that of the stationary phase, there will not be any interactions with the stationary phase. This contradiction can be partially resolved by the use of binary or tertiary mixtures with various polarities and successive processes with various mobile phases of increasing elution power during the separation process, i.e. mobile phases which composition in binary or ternary solvents with different polarities is modified during the separation. The use of a binary or tertiary mixture supposes that the micro-environment of the stationary phase will be exposed to concentration gradients for different solvents that have different polarities, which in turn will induce repartition chromatography phenomenons.

A solvent is as much an efficient eluent as his polarity is closer to that of the analyte, and finally to that of the stationary phase, because the polarity of the stationary phase is supposed to be close to that of the analyte. This makes the realization of an exhaustive chromatographic system very difficult: the exhaustiveness of a system where the mobile phase can contain analytes with very different polarities would suppose that the stationary phase would present a wide range of adsorptions, i.e. a very polar or a very apolar stationary phase which in turn would make the respective adsoprtion of apolar or very polar analytes very difficult.

Whithin a a limited range of analytes polarity levels, the selectivity is as good as a slight variation of the solvent polarity leads to a selective change in the adsorption balance ofanalytes which have close solubility levels.

For a given stationary phase, the mobile phase polarity can be modified, as well as other means to increase the selectivity of the chromatographic process: a competitor for analytes adsorption can be added, such as, for example, a cation or an anion or the analytes properties can be selectively modified by modifying the pH or the ionic force.

The following matrices can be used: matrices that include a stationary phase which grafts are made of polymers of molecules which have polar side and an apolar side, such as a macroporous copolymer made from a balance between two monomers: the divinylbenzene which is apolar and the N-vinylpyrrolidone which is polar.

Chromatography by adsorption on normal phase is based on the differential adsorption of analytes on a solid polar stationary phase, such as notably made with alumina or more importantly with silicates or hydrophilic polymers such as agarose gels or dextran; the mobile phase being apolar.

Starting with agarose, micro-particles are obtained by using an emulsiongelification process at hot temperature which uses firstly a solvent which is not miscible with water then, a stabilizer ; the said process being finished by getting rid of the solvent by using suction and filtration. Agarose gels can be reticulated with reticulating agents such as epichlorohydrine, 2,3 dibromopropanol or divinylsulfone. According to the percentage in agarose (2, 4, 6%), the commercial Sepharose gels are designated as 2B, 4B, 6B, respectively.

The CL Sepharose, which is more chemically and thermally stable, is reticulated with 2,3-dibromopropanol in strong alkaline conditions; the process is followed by hydrolysis of the sulfate groups in very reducing conditions, so as to make it non ionic or very weakly ionic.

Sephadex is a dextran gel which is reticulated with epichlorohydrin which is stable in alkaline, saline or weakly acidic conditions, but which is hydrolysed in strongly acidic or oxidative conditions. Sephadex gels (LH-20) and (LH-60) can be grafted with hydroxypropyl groups which are linked by ether bonds to the glucose units of the dextran chains, so as to modulate their polarity.

Silica is not soluble in water when the pH ranges between 2 and 8. Its polarity results from silanol groups (SiOH) at its surface; there are 4.6 groups by square nm (nanometer). In the silanol groups, the OH group is polar and is an electron donor in hydrogen bonds. A silanol group can stay free (free silanol) or be engaged in an hydrogen bond with a close silanol group (bound silanol) or be engaged in an hydrogen bond with a water molecule. The OH group of a free silanol can also be a proton donor to a water molecule (free silanol which is hydrated with a uni-molecular water layer), or to another polar molecule. Moreover, bound silanols can attract water molecules: in this case, there are hydrated silanols which are hydrated with a multi-molecular water layer; these are highly hydrated silica gels. Silica gels are very porous. According to their specific surface range (which ranges between 200 and 600 square meter per gram), they present more or less large pores and consequently a more or less important masking of the free silanols. The free silanol groups are “strong” adsorption sites which are fully available for hydrogen bonds. The free hydrated silanol groups and the bound silanol groups are also adsorption sites. On the contrary, the silanol groups which are hydrated with a multi-molecular water layer are rather used for partition chromatography. In strongly hydrated silica gels which specific surface is higher than 550 square meter per gram and which content in water is higher than 5%, partition chomatography is more important than adsorption chromatography. Commercialized silica gels have various particle sizes and are labeled by the number of free silanol groups per surface unit (for example, Lichosorb Si 100 has 2.95 free silanol groups per square nm for a specific surface of 309 square meter per gram, whereas Lichosorb 80 has 2.2 free silanol groups per square nm for a specific surface of 482 square meter per gram.)

In adsorption chromatography, the user tends to keep the same adsorption capacity of the sorbent whatever the mobile phase may be. To do so, the content in water of a solvent is adjusted to a level said to be “isoactivating water content” so that the adsorption energy of the solvent be equivalent to that of a reference solvent which has a given content in water (for example, the reference solvent for the absorption capacity of a silica gel with a specific surface of 550 square meter per gram could be ethyl acetate with 0.06% water.)

The polarity of silica can be modified by grafting. Polar grafts can be of different kinds: aminopropyl, paranitrobenzyl, alkylnitril(nitro), glyceropropyl(diol). The grafts can be made by silanization, i.e. by using the reactivity of alkoxysilanes or mono, di- or tri fonctional chlorosilanes. To make this reaction happen, silanes molecules should enter silica pores, thus the pore diameter should be larger than 10 nm. Moreover, the surface covered by a silane molecule can be twice as large as the surface covered by a silanol molecule (0.2 square nm and 0.4 square nm, respectively), thus the maximum grafting yield is 50%, i.e. 4 micromoles per square nm. Practically, the commercial phases that are grafted and non polymerized present a grafting rate of 3.5 to 3.7 micromoles per square nm. In a silanization reaction with tri-functional chlorosilanes, only two chloride atoms can react because of the dimensions of the molecules and the Si-Cl bond of the third chloride atom of the said silane can be hydrolyzed by water traces ; the resulting Si-OH bonds react with residual silanes which are contained in the reaction medium leading in turn to a polymerization reaction. Thus, the polymerized stationary phases have a large capacity but a strong resistance to mass transfer.

Reverse phase adsorption chromatography is based on differential adsorption of the analytes on a solid and apolar stationary phase, such as notably silica which are grafted with apolar groups; the mobile phase being of various polarity degrees, according to, for example, various proportions of more or less polar solvents (for example water and methanol or water and acetonitrile.)

If some matrices, such as styrene-divinylbenzene or pyrocarbon copolymers can be apolar “ex-abrupto,” the apolar functional groups that are grafted on stationary phases such as silica or Sepharose can be alkyl groups (C18 or C8 or C4) or phenyl groups. The grafting process of silica that are grafted with apolar groups is achieved by silanization, as is the grafting process with polar groups. It should be noted that, as in the the presence of residual silanols resulting from the hydrolysis of tri-functional reactive silane groups which have not been used during the synthesis reaction should be noted, as in the case of pure silica (polar) or silica that are polarly grafted, that there are residual silanols which result from the hydrolysis of reactive groups fo trifunctional silanes which have not reacted during the synthesis process. These residual silanols are covered with water molecules and those that are accessible create an environment which is adequate for partition chromatography on polar stationary phases: on one hand, the molecules of an organic solvent mixture (water—organic solvent) are preferably bound on the surface of apolar grafts, on the other hand, the solution molecules interact with the liquid stationary phase. The interaction mechanism is either a partition process of the analytes between the mobile phase and the liquid phase which is adsorbed, or an hydrophobic reaction between the solution molecules and the apolar stationary phase. Moreover, if their polarity is high enough, the solution molecules can move the molecules of the liquid polar stationary phase.

The residual silanol groups that are accessible can be eliminated (it is called the “end-capping” process) by a treament with trimethylchlorosilane (TCMS.) Apolar matrices which are different from silica grafted with C18 ou C8 ou C4 alkyl or phenyl groups can be used. For example, Phenyl and Octyl-Sepharose can be used in hydrophobic interaction chromatography and are obtained by coupling the Sepahrose CL reticulation with phenyl or octyl groups.

Styrene-divinylbenzene or pyrocarbon compolymer matrices can be used; these matrices have the advantage to have a large pH range (1 to 13 instead of 2 to 7.5) because the silica can react with OH ions. However, this disadvantage of silica was resolved by applying a siliconized coating on the pore surfaces; this is found in commercial stationary phases such as Capcell Pak.

One of the weak points of copolymer matrices, i.e. the mechanical resistance, can be improved by using macroporous copolymer matrices. These matrices include simultaneously a strongly reticulated part which is impermeable to solvents, and, macro-pores, without polymers. Other stationary phases, such as porous zirconium oxyde or porous graphite, naturally have the stability (pH range between 1 and 14) and the mechanical resistance qualities.

Another characteristic of these above-mentionned copolymer matrices is the presence of aromatic groups that can interact during the formation of donor-acceptor complexes with the analytes. Other copolymer matrices can be used, such as for example those which are made with vinyl alcohol or polymethacrylates.

In the present invention, the user can use known chromatographic separation methods which make use of ion exchange resins that are used to separate ionic analytes according to their electrostatic attraction to the stationary phase, the said stationary phase being made of a matrix grafted with functional ionized groups and able to adsorb counter-ions. The micro-particles of the ionized stationary phase receive the ions with opposite electrical charges and exclude the ions with the same electrical charge. The stationary phase matrices can be grafted silica or copolymer matrices. Because of their exclusion function and based on their composition (such as, for example, aromatic nucleus in polystyrene divinyl benzene copolymer matrices which generate interactions by pi electrons), matrices bring a contribution to the process which is added to that of their functional ionized groups. A competition for the binding to the stationary phase occurs between the ionized constituents of the mobile phase and the counter-ions that can be freed by the said stationary phase and thus can be exchanged. The mobile phase is a buffered solution which pH allows to control the electrostatic interactions of the solution constituents insofar as a certain value of the pH correspond to the electrical charge of the constituents. For example, the amino acids of proteins can be present in the solution under a zwitterionic form or under the form of anions or cations depending on the pH. Moreover, grafted matrices are porous (these are micro-particles made of porous silica micro-particles, or organic copolymers with microposrous structure or a macroporous structure such as poly(styrene/divinylbenzene) or polyacrylate); this induces, at the same time, a non ionic separation mechanism (for example, repartition mechanismes of molecules with a given polarity.) For example, non ionic analytes do not undergo electrostatic repulsion to penetrate inside the pores of the matrix. Thus, they undergo a repartition mechanism which is controlled by hydrophobic reactions and/or interactions by charge transfer.

A matrix can strongly or weakly exchange cations or anions. Strong cation exchangers (SCX), such as strong acids, can be sulfonic, i.e. grafted with functional sulfontate SO3- groups. Weak cation exchangers, cuch as weak acids, can be carboxylic, i.e. grafted with functional carboxylate CO2- groups. Strong anion exchangers (SAX), such as strong bases, can be quaternary ammoniums, i.e. grafted with functional NR3+groups, such as, for example, trimethylammonium. The weak anions exchangers, such as weak bases, can be non quaternary ammoniums, i.e. grafted with protonated forms of primary, secondary or tertiary amines (functional group NHR2+, such as, for example diethylaminoethylammonium.)

Currently used abbreviations include, for cation exchangers, CM, a weak acid, for carboxymethyl and also, SP and S, strong acids, for Sulfopropyl and methylSulphonate, respectively.

Also, currently used abbreviations include, for anions exchangers, DMAE and DEAE, weak bases, which mean Dimethylaminoethyl and Diethylaminoethyl, respectively, as well as TMA, Q and QAE, strong bases, which mean Trimethylaminoethyl, Quaternary Ammonium, Quaternary aminoethyl, respectively.

The eluting strength depends partially on the developer ion that is carried by the mobile phase.

In a first mode, ion pair chromatography or ion interaction chromatography makes use of the presence of ions with a charge opposite to that of the analyte in the mobile phase. In a mobile phase with weak dielectrical constant, each counter-ion can form a pair with a molecule of analyte with an opposite charge, by electrostatic attraction of coulombian type.

In a second mode, ion pair chromatography or ion interaction chromatography makes use of the presence of large ions (called counter-ions), in the mobile phase, which have an apolar side and a charge which is opposite to that of the analyte. The electro-neutrality results from the presence of co-ions of the same electrical charge as the ions of the analyte. In a mobile phase with a strong polarity such as water, in the presence of the analyte, each counter-ion can form a pair with a molecule of analyte by hydrophobic ionteractions. If an apolar stationary phase is used, such as a silica grafted with alkyl groups, some counter-ion can adsorb on the apolar grafts of the stationary phase, while 60 to 70% of them are maintained free. This is because they repel each other by coulombian repulsion which occur between ions of same charge when they are bound to alkyl groups that are too close. In other respects, while binding to the stationary phase by their apolar part, the counter-ions attract ions of opposite charge at their ionic part, like the co-ions which insure the electro-neutrality. An exchange occurs between the analyte ion and the co-ion which are of same charge. All things being equal, the retention capacity of the analyte by the stationary phase depends on the concentration in counter-ions. If the ions of the analyte are sufficiently hydrophobic, there will be a partition between the ion pairs (analyte ions/counter-ions) which bind on the free alkyl groups of the stationary phase and the solubilization of these same ions (analyte ions and counter-ions) in the mobile phase.

The analytes retention depends of their ionization degree, the organic solvents concentration and the counter-ions concentration in the mobile phase.

When analytes are able to form complexes a cation (Cu_+, Zn_+, Cd2+, Ni_+) or a donor or acceptor complex, ligand exchange chromatography and charge transfer chromatography, respectively, can be conducted.

In static mode ligand exchange chromatography, the metal cation, for example copper, is bound in the stationary phase, for example a pure silica, by ionic or covalent bonds, which leads to the coppering of the said stationary phases. Thus, a covalent binding of copper with silica is obtained in presence of ammonia, leading to silica covered with cupri-diamine silicates. These cupri-diamine silicates, which are bound to the stationary phase, are able to exchange ammonia with a sample constituent which is a doublet donor and in turn become a new ligand by forming a bond with the copper of the stationary phase. In the same time, the cupri-diamine silicates can solvate water molecules, which make them very hydrophilic. The retention of an analyte will depend on its donor characteristics (complexing ability) and on its hydrophilicity, as well as on the concentration in ammonia of the mobile phase which is generally a water-acetonitrile-ammonia mixture which concentration in water does not exceed 50% so as to maintain the stability of the stationary phase.

In dynamic mode ligand exchange chromatography, the mobile phase contains a complex, which is formed by a transition metal and a ligand that contains an hydrophobic chain, and the stationary phase, for example a silica grafted with apolar groups such as alkyl C18 groups, is able to bind this hydrophobic complex. In the mobile phase, the transition metal is in excess when compared to the hydrophobic ligand, so as to be free to also keep weak binding sites with solvent molecules. When analytes are able to form complexes with the transition metal, they are shared between the bonds with the metal in the mobile phase and the bonds with the metal which is included in complexes that are formed with the hydrophobic ligand; the hydrophobic ligand being adsorbed on the hydrophobic stationary phase.

In charge transfer chromatography, there is a competition between the analytes and the solvent to give (or accept) electrons to (or from) the grafts of the stationary phase, which are either electrons acceptors or donors, and form the respective complexes. The said complexes that are formed with the grafts are very specific because a graft can or cannot be acceptor or donor depending on the presence of of a second component which is a potential donor or acceptor. These complexes have a very weak enthalpy formation of a few kilojoules. Thus, silica which are grafted with aromatic compounds can be electron donors to a particular analyte or a particular solvent which is an electron acceptor, and form complexes. This particular solvent is called the polar modifyer of the mobile phase. In such a system, the solvent molecules can also solvate the grafts of the stationary phase. Consequently, there could be a competition between the analyte and the polar modifyer to receive the electrons of the stationary phase; however, the analyte can also interact with the grafts which are solvated by the polar modifyer. Finally, there is a competition between the analytes and the polar modifyer to give (or accept) electrons to (from) the free non-solvated grafts of the stationary phase. The retention of the analytes is quite as a strong as the number of free grafts in the stationary phase is high and the number of aromatic molecules per graft and the spatial density of these molecules are high. All things being equal, the competition for binding to the stationary phase depends on the concentration in polar modifyer of the mobile phase.

The above-mentioned principles are more complicated in the case of molecules such as peptides or proteins which are polymers of amino acids; each of these molecules has its own polarity, its net global charge for a given pH and its own spatial conformation which depends on the polarity of the solvent. The spatial conformation results from the facts that the functional groups of same polarity as that of the solvent are exposed on the surface of the molecule, whereas the functional groups of opposite polarity are pushed inside the molecule. Another possibility is that the solvent molecules self-assemble (a phenomenon called solvatation) around the functional groups of the analyte which has an opposite polarity, thereby creating a sort of masking pocket. This phenomenon results in hiding the polarity of the said functional groups of the sample constituents which have a polarity opposite to that of the solvent.

In aqueous solutions, the hydrophilicity of a protein or a peptide depends on its amino acids composition. When the proportion of hydrophilic or polar amino acids is high within a sequence, the hydrophobic or apolar amino acids (isoleucine, valine, leucine, phenylalanine) are pushed inside the molecule. On the contrary, when the proportion of hydrophobic or apolar amino acids is high within a sequence, there is a more direct interaction between some hydrophobic amino acids and the aqueous medium.

Thus, a first mean to increase the selectivity is to make use of change in the composition of binary or tertiary mixtures of solvents with different polarities so as to obtain a variation of the polarity of the mobile phase and thus, completely modify the spatial conformation of the protein. Thus, spatial conformations of the peptides or the proteins which are specific of the new polarity and quite as distant from the initial conformation (denaturated) as the new polarity of the binary or tertiary solvent is distant from its inital polarity can be obtained. Starting with a mixture of, for example, water and acetonitrile which leads to push the hydrophobic or apolar amino acids inside the proteins which have a high proportion of hydrophylic or polar amino acids, the addition of a less polar solvent modify the proteins conformation and lead to expose the functional groups that are less polar or apolar. The peptides or proteins are then adsorbed on a stationary phase grafted with apolar groups such as C18, C8 or C4 alkyl groups. The proteins or peptides which have the most amino acids with apolar functional groups are the most slowed down.

A second mean to increase the selectivity is to use components which modify the solvatation of functional groups such as salts. At weak ionic force, the hydrophobic or apolar functional groups are surrounded with water molecules which self-assemble. On the contrary, at strong ionic force, the hydrophobic or apolar functional groups are exposed while the surrounding water molecules are disorganized. Hydrophobic interaction chromatography makes use of a strong ionic force at first, then the ionic force is decreased until the hydrophobic or apolar functional groups of proteins and peptides are masked in aqueous medium with a weak ionic force. If an apolar stationary phase, which is grafted with C18, C9 or C4 alkyl groups, is used, then the proteins which have the mosts hydrophobic functional groups are those which are the most slowed down. For this type of chromatography, Phenyl and Octyl-Spharose are often used.

Several models were developed to describe the laws of separation in chromatography, in particular by setting parameters for the theoretical plate height in the micro-column.

Different models (Van Deemter, Giddings, Huber, Knox, Horvath) make use of different equations to calculate the theoretical plate height H.

For example, Van Deemter equation takes the following form:

H=A/d+Bd+C A refers to the axial diffusion,

B refers to the incomplete mass transfer between the mobile and the stationary phase,

C refers on one hand, to the unequal travel lengths to cross the column and on the other hand, to the difficulty for the analytes and the mobile phase to access to the mesh formed by the stationary phase; in the optimal method, the mobile phase and the analytes reach the said mesh by convection rather than by diffusion,

d is the flow of the mobile phase through the column.

All of the models convey, among other things, the fact that the axial diffusion is a phenomenon which is quite as much marked as the molecules are small and opposes the good quality of separation, the fact that the axial diffusion is quite as limited as the speed of the mobile phase is high ; however, in the same time, the mass transfer between the stationary and mobile phases is quite as good as the speed of the mobile phase is low. Except for size exclusion chromatography, these models also convey the fact that the quality of the separation is quite as good as the access by convection of the mobile phase to the mesh of the stationary phase is better than the access by diffusion or, in other words, that the particles diameter is small.

In the present invention, the user can use known electrochromatographic separation methods, i.e. methods which make use of electrophoresis which is conducted in a capillary channel that contains a stationary phase and which undergoes an electrical field between its two extremities (Manz A, Effenhauser C S, Burggraf, Harrison D J, Seiler K, Fluri K. Electroosmotic pumping and electrophoretic separations for miniaturized chemical analysis systems. J. Micromech. Microeng, 1994, 4, 257-265 Jacobson S C, Kutter J P, Culbertson C T, Ramsey J M. Rapid electrophoretic and chromatographic analysis on microchips.) Analytes are simultaneously separated according to their electrophoretic mobility and to their repartition coefficient between the mobile phase and the stationary phase (Altria K D. Overview of capillary electrophoresis and electrochromatography, Journal of Chromatography A, 1999, 856, 443-463; Quirino J P, Terabe S. Electrokinetic chromatography, Journal of Chromatography A, 1999, 465-482 ; Smith N W, Carter-Finch A S, Electrochromatography, Journal of Chromatography A, 2000, 892, 219-255; Bartle K D, Carney R A, Cavazza A, Cikalo M G, Myers P, Robson M M, Roulin S C P, Sealey K. Capillary electrochromatography on silica columns : factors inflencing performance. Journal of Chromatography A, 2000, 892, 279-299; Pyell U. Advances in column technology and instrumentation in capillary electrochromatography, Journal of Chromatography A, 2000, 892, 257-278; Angus P D A, Demarest C W, Catalano T, Stobaugh J F. Aspects of column fabrication for packed capillary electrochromatography. Journal of Chromatography A, 887, 2000, 347-345; Rapp E, Bayer E. Improved column preparation and performance in capillary electrochromatography. Journal of Chromatography A, 2000, 887, 367-378; Luedtke S, Adam Th, von Doehren N, Unger K K. Towards the ultimate minimum particle diameter of silica packings in capillary electrochromatography, Journal of Chromatography A, 2000, 887, 339-346; Liu C H, Stationary phases for capillary electrophoresis and capillary electrochromatography. Electrophoresis 2001, 22, 612-628; Hayes J D, Malik A. Sol-gel open tubular ODS columns with reversed electroosmotic flow for capillary 5 electrochromatography. Anal. Chem. 2001, 73, 987-996; Roed L, Lundanes E, Greibrokk T. Non-aqueous electrochromatography on continuous bed columns of solgel bonded large-pore C30 material: separation of retinyl esters. J. Microcolumns Separations. 2000.12(11).561-567.)

An electrical field can be externally applied along the columns, as described in the following docuement (Hayes M A. Extension of external voltage control of electro-osmosis to high pH buffers. Anal Chem. 1999, 71, 3793-3798.)

A micellar electrochromatography can be applied on miniaturized supports, as described in the following document (Culbertson C T, Jacobson S C, Ramsey J R. Micro-chip device for high efficiency separations. Anal. Chem. 2000, 72, 5814-5819.)

Eelution gradients, and notably elution micro-gradients, can be used (Que A H, Kahle V, Novotny M V. A micro-gradient elution system for capillary electrochromatography. J. Micro-column separations. 2000, 12(1), 1-5.)

The separation and notably the separation of peptides or proteins can be achieved by micro-chromatography, micro-electrochromatography or microelectrophoresis separation processes.

The book<<Protein Liquid Chromatography. Journal of Chromatography Library, 2000, vol 61, M. Kastner Ed., Elsevier, describes peptides or proteins separation in articles which describe their separation by inverse phase chromatography (Schlüter H. Reversed-Phase Chromatography, pp. 147-223), by ion exchange chromatography (Roos P. Ion Exchange Chromatography. pp. 3-88), by hydrophobic interactions chromatograhy (Jacob L R . Hydrophobic Interaction Chromatography. pp. 235-267), by hydroxyapatite chromatography (Deppert W R, Lukacin R, Hydroxyapatite chromatography, pp. 271-297), by immobilized metal ion affinity chromatography (Kastner M, Immobilized Ion Affinity Chromatography, pp. 301-377), by chromatofocusing (Lukacin R, Deppert W R, Chromatofocusing, pp. 385-413), by molecular ligand affinity chromatography (Kirchberger J., Bohme H J, Dye-Affinity Chromatography, pp. 415-446), by displacement chromatography (Schlüter H, Jankowski J, Displacement Chromatography, pp. 505-522), by liquid liquid partition chromatography (Hansson U B, Wingren C. Liquid liquid partition chromatography, pp. 469-502) and by residual cysteins binding chromatography (Whitney D. Covalent Chromatography, pp. 639-663).

A protein and peptide chromatographic separation wich uses 1.5 micron non-porous monodisperse reversed phase silica can be used (Jilge G, Janzen R, Giesche H, Unger K K, Kinkel J N, Hearn M T W. Retention and selectivity of proteins and peptides in gradient elution of non-porous monodisperse 1.5 micron reversed phase silica. Journal of Chromatography A. 1987, 397, 71-80; Jilge G, Janzen R, Giesche H, Unger K K, Kinkel J N, Hearn M T W. Mobile phase and surface mediated effects on recovery of native proteins in gradient elution on non-porous monodisperse 1.5 micron reversed phase silica. Journal of Chromatography A. 1987, 397, 80-89.) Peptides and proteins can be separated by anion-exchange chromatography on a non-porous poly(sytene-divinylbenzene) polymeric 3-micron phase (Regnier F E, Rounds M A. Synthesis of a non-porous, polystyrene-based anion-exchange packing material and its application to fast high-performance liquid chromatography of proteins. Journal of Chromatography A. 1988, 443, 73-83.)

Peptides and proteins can be separated by hydrophobic interactions chromatography on monodisperse non-porous 1.5-micron silica (Jilge G, Janzen R, Giesche H, Unger K K, Kinkel J N, Hearn M T W. Performance of non-porous monodisperse 1,5 micron bonded silicas in the separation of proteins by hydrophobic interaction chromatography. Journal of Chromatography A. 1987, 397, 91-97.)

Proteins can be separated in solutions at pH 5, 7 and 9 by metal ion affinity chromatography; metal ions are copper ions which are immobilized on a Sepahrose CL4B stationary phase obtained by an epoxy coupling process and by using the N-(2pyridylmethyl) aminoacetate tridendate chelator ligand (Chaouk H, Hearn M T W. New ligand, N-(2-pyridylmethyl)arninoacetate, for use in the immobilised metal ion affinity chromatographic separation of proteins. Journal of Chromatography A, 1999, 852, 105-115.)

Synthetic peptides which have a more or less large number of histidine residues can be retained by using affinity chromatography with immobilized metal ions on Sepharose CL-4B and by using the iminoacetic acid ion as tridendate chelator ligand or the nitriloacetic acid ion as tetradendate chelator ligand (Kronina V V, Wirth H J, Hearn M T W. Characterization by immobilized metal ion affinity chromatographic procedures of the binding behaviour of several synthetic peptides designed to have high affinity for Cu(II) ions. Journal of Chromatography A, 1999, 852, 261-272.)

A micellar chromatography for peptides can be used, as described in the following article (Kord A S, Khaledi M G. Selectivity of organic solvents in micellar liquid chromatography of amino-acids and peptides. J. Chromatogr. 1993, 631, 1225-132.)

The separation of biological samples can be achieved by microelectrophoresis with a preliminary step of enrichment (Lichtenberg J, Verpoorte E, de Rooij N. Sample preconcentration by field amplification stacking for microchip-based capillary electrophoresis. Electrophoresis 2001, 22, 258-271; Wu X Z, Hosaka A, Hobo T. An on-line electrophoretic concentration method for capillary electrophoresis of proteins. Anal. Chem, 1998, 70, 2081-2084; Tragas C, Pawliszyn J. On-line coupling of high performance gel filtration chromatography with imaged capillary isoelectric focusing using a membrane interface. Electrophoresis 2000, 21, 227-237; Cappiello A, Berloni A, Famiglini G, Mangani F, Palma P. Micro-SPE method for sample introduction in capillary HPLC/MS. Anal. Chem 2001, 73, 298-302; Timperman A T, Aebersold R. Peptide electro-extraction for direct coupling of in-gel digests with capillary LC-MS/MS for protein identification and sequencing. Anal. Chem. 2000, 72, 4115-4121; Tong W, Link A, Eng J K, Yates J R III. Identification of proteins in complexes by solid-phase micro-extraction/multistep elution/capillary electyrophoresis/tandem mass spectrometry. Anal Chem 1999, 71, 2270-2278; Figeys D, Ducret A, Yates J R III, Aebersold R. Protein identification by solid-phase micro extraction/multistep elution/capillary electyrophoresis/tandem mass spectrometry. Nature Biotechnology, 1999, 14, 1579-1583; Stegehuis D S, Irth H, Tjaden U R, van der Greef J. Isochatophoresis as on-line concentration pretreatment technique in capillary electrophoresis. J. Chromat, 1991, 538(2), 393-402.; Polson N A, Savin D P, Hayes M A. Electrophoretic focusing preconcentration technique using a continuous buffer system for capillary electrophoresis. J. Microcolumn Separations, 2000, 12(2),98-106.) Iso-electric focusing, i.e. a pH gradient along a separation micro-capillary, can be used in electrophoretic separation. This gradient can be obtained by using a group of small ampholyte molecules that are charged according to their isolelectric point (Ip), such as those synthesized from acrylic acid and polyamines, or obtained by epichlorhydrine coupling. The pH gradient can generally range from 3 to 10. The gradient can also be obtained by grafting acrylamide monomers in a polyamide gel; the acrylamide monomers are modified and bear ionizable chemical groups with acid or basic PK. In this case, the pH gradient can range from 1 to 12.5 (Kawano Y, Ito Y, Yamakawa Y, Yamashino T, Horii T, Hasegawa T, Ohta M. Rapid isolation and identification of staphylococcal exoproteins by reverse phase capillary high performance liquid chromatography-electrospray ionization mass spectrometry.FEMS Microbiol Lett. Aug. 1, 2000 ;189(1):103-8; Bean S R, Lookhart GL.Electrophoresis of cereal storage proteins. J Chromatogr A. Jun. 9, 2000 ;881(1-2):23-36; Issaq H J. A decade of capillary electrophoresis. Electrophoresis. 2000 Jun;21(10):1921-39; Herrero-Martinez J M, Simo-Alfonso E F, Ramis-Ramos G, Gelfi C, Righetti P G. Determination of cow's milk in non-bovine and mixed cheeses by capillary electrophoresis of whey proteins in acidic isoelectric buffers. J Chromatogr A. May 12, 2000 ;878(2):261-71; Jensen P K, Pasa-Tolic L, Peden K K, Martinovic S, Lipton M S, Anderson G A, Tolic N, Wong K K, Smith R D. Mass spectrometric detection for capillary isoelectric focusing separations of complex protein mixtures. Electrophoresis. 2000 Apr;21(7):1372-80; Shen Y, Berger S J, Anderson G A, Smith R D. High-efficiency capillary isoelectric focusing of peptides. Anal Chem. May 1, 2000 ;72(9):2154-9; Shimura K, Zhi W, Matsumoto H, Kasai K. Accuracy in the determination of isoelectric points of some proteins and a peptide by capillary isoelectric focusing: utility of synthetic peptides as isoelectric point markers. Anal Chem. Oct. 1, 2000 ;72(19):4747-57; Yang L, Lee C S, Hofstadler S A, Pasa-Tolic L, Smith R D. Capillary isoelectric focusing-electrospray ionization Fourier transform ion cyclotron resonance mass spectrometry for protein characterization. Anal Chem. Aug. 1, 1998 ;70(15):3235-41; Chartogne A, Tjaden U R, Van der Greef J. A free-flow electrophoresis chip device for interfacing . capillary isoelectric focusing on-line with electrospray mass spectrometry. Rapid Commun Mass Spectrom. 2000;14(14):1269-74; Wen J, Lin Y, Xiang F, Matson D W, Udseth H R, Smith R D. Microfabricated isoelectric focusing device for direct electrospray ionization-mass spectrometry. Electrophoresis. 2000 Jan;21(1):191; Rossier J S, Schwarz A, Reymond F, Ferrigno R, Bianchi F, Girault H H. Microchannel networks for electrophoretic separations. Electrophoresis. 1999 Apr-May;20(4-5):727-31; Hofmann O, Che D, Cruickshank K A, Muller U R. Adaptation of capillary isoelectric focusing to microchannels on a glass chip. Anal Chem. Feb. 1, 1999 ;71(3):678-86; Horka M, Willimann T, Blum M, Nording P, Friedl Z, Slais K. Capillary isoelectric focusing with UV-induced fluorescence detection. J Chromatogr A. May 4, 2001 ;916(1-2):65-71; Hu J P, Lanthier P, White T C, McHugh S G, Yaguchi M, Roy R, Thibault P. Characterization of cellobiohydrolase I (Cel7A) glycoforms from extracts of Trichoderma reesei using capillary isoelectric focusing and electrospray mass spectrometry. J Chromatogr B Biomed Sci Appl. Mar. 10, 2001 ;752(2):349-68; Shihabi ZK. Stacking in capillary zone electrophoresis. J Chromatogr A. Dec. 1, 2000 ;902(1):107-17; Gubitz G, Schmid M G. Recent progress in chiral separation principles in capillary electrophoresis. Electrophoresis. 2000 Dec;21(18):4112-35; Mao Q, Pawliszyn J, Thormann W. Dynamics of capillary isoelectric focusing in the absence of fluid flow: high-resolution computer simulation and experimental validation with whole column optical imaging. Anal Chem. Nov. 1, 2000 ;72(21):5493-502; Martinovic S, Berger S J, Pasa-Tolic L, Smith R D. Separation and detection of intact noncovalent protein complexes from mixtures by on-line capillary isoelectric focusing-mass spectrometry. Anal Chem. Nov. 1, 2000 ;72(21):5356-60; Huang T, Wu X Z, Pawliszyn J. Capillary isoelectric focusing without carrier ampholytes.Anal Chem. Oct. 1, 2000 ;72(19):4758-61;Barkemeyer B M, Hempe J M.. Effect of transfusion on hemoglobin variants in preterm infants. J Perinatol. 2000 Sep;20(6):355-8; Sugano M, Hidaka H, Yamauchi K, Nakabayashi T, Higuchi Y, Fujita K, Okumura N, Ushiyama Y, Tozuka M, Katsuyama T. Analysis of hemoglobin and globin chain variants by a commonly used capillary isoelectric focusing method. Electrophoresis. 2000 Aug;21(14):3016-9 ; Lupi A, Viglio S, Luisetti M, Gorrini M, Coni P, Faa G, Cetta G, Iadarola P. Alphalantitrypsin in serum determined by capillary isoelectric focusing. Electrophoresis. 2000 Sep;21(15):3318-26; Martinovic S, Pasa-Tolic, Masselon C, Jensen P K, Stone C L, Smith R D. Characterization of human alcohol dehydrogenase isoenzymes by capillary isoelectric focusing-mass spectrometry. Electrophoresis. 2000 Jul;21(12):2368-75Chartogne A, Tjaden U R, Van der Greef J. A free-flow electrophoresis chip device for interfacing capillary isoelectric focusing on-line with electrospray mass spectrometry. Rapid Commun Mass Spectrom. 2000;14(14):1269-74.) In electrophoretic separation, isochatophoresis, i.e. an electroseparation with an electrical field gradient can be used (Chen S, Lee M L. Automated instrumentation for comprehensive isotachophoresis-capillary zone electrophoresis. Anal. Chem. 2000, 72(4):816-20.)

The above-mentioned separation methods can easily be applied in the fractionation micro-columns 2 or the secondary fractionation micro-columns 10.

In a preferential realization mode, the fractionation micro-columns contain chromatographic separation means.

In the case of multiple groups of fractionation micro-columns 2, the specific selectivity of a group is determined by the nature of the stationary phase contained in the fractionation micro-columns 2 that form the group.

According to the separation method that is used, the selectivity of the fractionation micro-columns 2 of a group is determined by the intrisic polarity and the solvophobicity of the stationary phase, and by the polarity, the amphipaticity and the solvophobicity of the functional groups that are grafted on the stationary phase. The selectivity of the fractionation micro-columns 2 is secondarily determined by other criteria such as the micro-porosity, the macro-porosity, the ability to exchange ions or interact with ion pairs or to exchange ligands or to transfer charges or to develop affinity reactions with the said stationary phase, or criteria such as the presence of a pH gradient along the said fractionation micro-columns 2 (the length of the said pH gradient being as large as the length of the said fractionation micro-columns 2.) The said selectivity is thirdly determined by an electrical field that is applied on stationary phases of the said fractionation micro-columns 2 (Method of electric field flow fractionation wherein the polarity of the electric field is periodically reversed. U.S. Pat. No. 6113819.)

During the separation of the constituents of a sample, each group of fractionation micro-columnns 2 receive a mobile phase, of an eluent kind, that is specific of the said fractionation micro-columns and that suits to the nature of the stationary phase which is contained in the fractionation micro-columns 2.

In a variant of the invention which is adjusted to a realization mode in which the device includes secondary fractionation micro-columns 10, the separation in the fractionation micro-columns 2 is done with a first chromatography method and the separation in the corresponding secondary fractionation micro-column 10 is done with a second chromatography method which is different from the first chromatography method. Taking into account the first separation method and the selectivity of a fractionation micro-column 2, molecules that have similar migration speed will be found together in a captured fractionation product. Thus, the selectivity of the second separation method is preferably selected as different from the selectivity of the first method. For example, the first chromatography method is an ion exchange chromatography, the second method is an hydrophobic interaction chromatography method.

In the case of separation by chromatography, the detection is done with micro-cantilevers in the detection zone 10, is followed or possibly preceded by a supplementary detection by one of the methods known by the skilled man, for the detection of the eluted molecules, directly or after hyphenation, for example, mass spectrometry that was previously mentioned.

Separation by chromatography micro-columns was described. Separation by other means (some of them were mentioned above) can be used to obtain different types of selectivity.

In a variant of the invention, the fractionation micro-columns contain microelectrophoresis separation means, of the zone micro-electrophoresis kind, or the microisochatophoresis kind, or the micellar micro-electrophoresis kind, or the iso-electrical focusing micro-electrophoresis kind which is obtained by the presence of a pH gradient along the length of the said micro-channels, the said pH gradient spreading on a range which is quite as large as the length of the micro-channels. In this case also, the detection is done with micro-cantilevers and possibly by spectrometry.

In a variant of the invention, the separation in the fractionation microcolumns is done by a method called Field Flow Fractionation (Suslov S A, Roberts A J., Modeling os sample dynamics in rectangular asymetrical field flow fractionation channels. Anal. Chem. 2000, 72(18), 4331-45.)

In a variant of the invention, the micro-channels of the micro-columns are equipped with nano-electrodes along their length (see U.S. Pat. No. 6 123 819.) The molecules, which are carried by an eluent, are as much slowed down as their charge interact with an electromagnetic field which is created by the nano-electrodes.

Rectilinear and parallel fractionation micro-columns were described. Different designs for the fractionation micro-columns 2 can be used. For example, the fractionation micro-columns 2 can be rectilinear, curved or sinuous. They are fabricated, partially or totally, by using techniques which are used in silicon, glass, ceramic or plastic micro-fabrication. In a realization mode, the micro-column are monoliths.

The fabrication methods of the supports are described in the following description.

In general, beds of micro-columns, i.e. grooves are made on a support and are planned to be covered and closed with another support which has a planar surface where the corresponding grooves can be directly etched when the supports are made of silicon or glass or ceramic.

For example, the fractionation micro-columns 2 and the said secondary micro-channels 10 can be fabricated, partially or totally, with the techniques that re used in microfabrication, such as photo-etching, micro-molding, micro-embossing, photopolymerization or thermopolymerization (He B, Talt N, Regnier F. Fabrication of Nanocolumns for liquid chromatography. Anal. Chem, 1998, 70, 3790-3797; Regnier F E, He B, Lin S, Busse J. Chromatography and electrophoresis on chips: critical elements of future integrated, microfluidic analytical systems for life science, TIBTECH, 1999, 17, 101-106; Pesek J J, Matyska M T. Open tubular capillary electrokinetic chromatography in etched fused-silica tubes. Journal of Chromatography, 2000, 887, 31-41.)

The micro-particles network that constitutes the stationary phases in microcolumns can be obtained by photo-etching when the said integrated supports are made of silicon or glass or ceramic (He B, Regnier F. Microfabricated liquid chromatography columns based on collocated monolith support structures, 451-455; He B, Tait N, Regnier F. Fabrication of nanocolumns for liquid chromatography. Anal. Chem., 1998, 70, 3790-3797.)

The micro-particle network can be obtained by micro-molding (when supports are made of plastics) or micro-embossing or in situ photo-polymerization or in situ thermo-polymerization or by inserting micro or nano-rods inside the micro-columns (Gusev I, Huang X, Horvath C. Capillary columns with in situ formed porous monolithic packing for micro-high performance liquid chromatography and capillary electrochromatography, Journal of Chromatography A, 1999, 855, 273-290; Yu C., Svec F., Frechet J. Towards stationary phases for chromatography on a microchip: molded porous polymer monoliths prepared in capillaries by photo-initiated in situ polymerization as separation media for electrochromatography. Electrophoresis 2000, 21, 120-127; Svec F., Peters E. C., Sykora D., Frechet J. Design of the monolithic polymers used in capillary electrochromatography columns. J. of Chromatography A., 2000, 887, 3-29. Josic D., Buchacher A., Jungbauer A. Monoliths as stationary phases for separation of proteins and polynucleotides and enzymatic conversion. Journal of Chromatography B, 2001, 752, 191-205; Ngola S M, Fintschenko Y., Choi W Y, Shepodd T J. Conduct-as-cast polymer monoliths as separation media for capillary electrochromatography ; Pursch M, Sander L C. Stationary phases for capillary electrochromatography. Journal of Chromatography A, 2000, 887, 313-326.) Microparticles can also be immobilized in a continuous column bed (Adam T., Unger K K, Dittmann M M, Rozing G P. Towards the column bed stabilization of columns in capillary electroendosmotic chromatography. Immobilization of microparticulate silica columns to a continuous bed. J. of chromatography A, 2000, 327-337; Roed L, Lundanes E, Greibrokk T. Non-aqueous electrochromatography on continuous bed columns of sol-gel bonded large-pore C30 material: separation of retinyl esters. J. Microcolumns Separations. 2000, 12(11), 561-567).

The micro-particle network that constitutes the stationary phases of chromatography micro-columns can be coated with a thin hydrophobic or hydrophilic film and that can be submitted to coupling chemistries known by the skilled man so as to graft molecules that are characterized by their polarity or their amphipathicity.

The chemical etching increases the retention properties as was shown in the following article (Pesek. Protein and peptides separations on high surface area capillaries. Electrophoresis, 1999, 20, 2343-2348.)

Micro-channels can be filled with polymeric monoliths micro-rods that are appropriate for protein separation by electrochromatography or by micro-high pressure liquid chromatography (Hjerten. Electroosmosis and pressure-driven chromatography in chips using continuous beds. Anal. Chem, 2000, 72, 81-87.)

Stationary phases for chromatography can be obtained by molding with silicon molds. The very high precision of plastic micro-molding techniques is directly related to that of silicon molds. This precision is at the required level to be able to fabricate chromatography stationary phases that are directly moulded in plastic by using silicon molds that are designed to make stationary phases constituted by a very thin microparticles network, such as, for example, a network made of 5 micron-ridges cubes, separated by 500 nanometers spaces.

<<Molecular Imprinting>> techniques can be used; these techniques are used to make plastics mimick molecular recognition surfaces for molecules A that ressemble molecules B which have an affinity for thre said molecules A (Rachkov A, Minoura N. Towards molecularly imprinted polymers selective to peptides and proteins. The epitope approach. Biochim. Biophys Acta 2001. 1544(1-2). 255-266; Haupt K, Mosbach K. Plastic antibodies: developments and applications. Trends Biotech 1998. 16(11). 468-75; Ramstrom O, Mosbach K. Sybthesis and catalysis by molecularly imprinted materials. Current Opinion Chem. Biol. 1999, 3(6). 759-64; Heegaard N H, Nilsson S, Guzman N A. Affinity capillary electrophoreis: important application areas and some recent developments . J. chromatography B Biomed Sci Appl. 1998. 715, 29-54.; Schweitz L, Petersson M, Johansson T, Nilsson S. Alternative methods providing enhanced sensitivity ansd selectivity in capillary electro-separation experiments. Journal of Chromatography A, 2000, 892, 203-217.)

In order to miniaturize a chemical or biochemical analysis system, ducts, the conduits and the components that drive and receive the fluids (micro-channels, microreservoirs, micro-mixers, micro-columns, etc.) and the components that manage the flows of fluids and reagents (micro-floodgates, micro-pumps, micro-sensors, microheaters, etc.), should be miniaturized and finally, the connections within and toward the exterior of the device should be established (Elwenspoek M, Lammerink T S J, Miyake R, Fluitman J H J. Towards integrated microliquid handling systems. J. Micromech. Microeng. 1994, 4, 227-245. _Verpoorte E M J, van der Schoot B H, Jeanneret S, Manz A, Widmer H M, de Rooij N F. Three-dimensional micro flow manifolds for miniaturized chemical anlysis systems . J. Micromech. Microeng.1994, 4, 246-256, 1994 _ Schabmueller C G J, Koch M, Evans A G R, Brunnschweiler A. . Design and fabrication of a microfluidic circuitboard. J. Micromech.Microeng. 1999, 9, 176-179._ Lammerink T S J, Spiering V L, Elwenspoek M, van den Berg A. Modular concept for fluid handling system. Proc. IEEE Micro Electro Mechanical Systems, 1996, San Diego pp389-384_ Richter M, Prak A, Eberl M, Leeuwis H, Woias P, Steckenbom A. 1997. A chemical microanalysis system as a microfluid demonstrator. Proc. Transducers 97, IEEE Chicago, pp303-306._ Kovacs G T A, Petersen K, Albin M. Silicon micromachining: sensors to systems. Analytical Chemistry, 1996, 407A-412A _ Gravesen P, Branebjerg J, Jensen O S.. Microfluidics. A review.J. Micromech. Microeng. 1993. 3. 168-182. _ Shoji S, Esahi M. Microflow devices and systems. J. Micromech. Microeng. 1994. 4. 157-171. _ Büttgenbach S., Robohm C. Microflow devices for miniaturized chemical analysis systems. SPIE 1998, vol 3539, 51-61_ Urban G, Jobst G, Moser I. Chemo-and biosensor Microsystems for clinical applications. SPIE 1998. Vol 3539, 46-50).

The fabrication techniques used for the supports of the micro-channels and micro-ducts can be different from that used for micro-components, and a final assembling can be done, preferably using an automated way.

Aspect ratio is one the criteria which helps to select a micro-fabrication mode for a given part of a miniaturized device for chemical or biochemical analysis; aspect ratio represents the ability to abide by the dimensions which are determined by a scale drawing, particularly to abide by a profile with broken and not curved lines.

For the fabrication of the miniaturized systems—at least in a first phase of fabrication—the skilled man starts by using planar and flat supports, called two dimensional (2D) supports, where most of components are made by etching, cutting and material deposition on planar surfaces.

Less and less flat components can be made while abiding more and more by a fabrication profile by using substractive techniques, such as chemical etching, physical ablation and additive techniques, such as deposition (electroplating), electroless plating, chemical vapor deposition (CVD and PECVD) and finally through micro-molding and micro-stamping techniques.

In order to overcome the fabrication limits, notably the maximum depth that can be obtained by manufacturing (usinage), and the limits of the deposition or molding techniques that are used to make devices where 3D forms have a high height/surface ratio, several parts, called <<sub-components>>, can be assembled ; these sub-components have a flatness degree which is compatible with flat surfaces manufacturing techniques. Sub-components which are just flat enough and thin enough to be microfabricated, can be fabricated. Then, these sub-components are superposed and fused or sticked together after possible fitting or interlocking, thereby constituting the required micro-system (U.S. Pat. No. 5 932 315: Microfluidic structure assembly with mating microfeatures _ U.S. Pat. No. 5 611 214. Microcomponent sheet architecture U.S. Pat. No. 5252294. Micromechanical structure.)

To make this solution applicable, the required micro-system should be contained in a relatively flat volume which results from the superposition of subcomponents which are themselves thin and flat.

Some components may not not be micro-fabricated by planar surfaces micro-manufacturing techniques. This can be the case because their shape is too sophisticated to be technically realizable or to be fabricated at a reasonable cost. It can be also the case because the required function of these components is not suited to miniaturization or to miniaturization techniques. The consequence of such a situation is that some components will remain at a micro-scale, and that the packaging will be designed in such a way that macro-parts will be assembled with micro-parts (Van der Schoot B H, Interfacing micro and macro mechanical worlds. J. Micromech. Microeng.1995, 5, 72-73.)

Techniques that can be used include photolithographic wet chemical etching, dry etching with photonic or particle radiations, micro-shaping with lasers or micro-tools, cutting-up, ablation, fusion or anodic assembling, sticking, welding, molding, hot-embossing, punching, drilling, electro-deposition, chemical vapor deposition and lamination.

Wet etching of silicon and its derivatives is well known in the microelectronics industry. It can be isotropic. It can also be anisitropic when etching direction is controlled by taking profit from crystal orientation and from etching chemical solutions properties (Sato K, Shikida M, Yamashiro M, Tsunekawa M, Ito S. Characterization of anisotropic etching properties of single crystal silicon: surface roughening as a function of crystallographic orientation. 11th IEEE International Workshop on MEMS, Heidelberg, Germany, 1998, 201-206.)

Wet etching techniques, which are either isotropic or anisotropic, present numerous variations. The knowledge in physics of materials, orbital chemistry, radiation physics, material doping, helps to take profit from the atomic structure of various materials which are used, help to conceive methods for controlling the direction, the depth and the stopping of etching on various layers.

The above-mentioned techniques present numerous variations. The knowledge in surface treatment helps to improve the qualities which are requested for the materials during fabrication or the qualities which are requested for the finished product.

The knowledge in thermophysics and differential thermochemistry between two materials helps to foresee new techniques for fusion, molding, stamping, embossing, punching, especially for plastics.

A polymer micro-fabrication technique which is based on stereolithography can be used, in particular for quick three dimensional (3D) prototyping.

The terms “bulk micromachining” and “surface micromachining” are used when a material is etched in the block and when a material is etched only superficially, respectively.

All these micro-fabrication techniques are applicable, not only to the fabrication of finished products, but also to the fabrication of the tools which are used to achieve these micro-fabrications, as well as to the fabrication of hot-embossing micromolds and micro-matrices which are used for mass production of micro-devices.

Among the criteria which are used to select a fabrication mode and a material, the intrinsic qualities of the materials which are included in the finished product, and the possibilities to control the fabrication costs can be mentioned.

Some techniques are not well suited to mass production: dry etching through photonic or particle radiation (Bean. Anisotropic etching of silicon. 1978, Vol ED25(10), pp. 1185-1193. IEEE Transactions of Electron devices), laser ablation, etching with micro-tools.

However, these techniques can be used as a first step in a mass production process of products which are made of plastic, ceramic or metal, by using a process called <<by replication>>(Niggemann M., Ehrfeld W., Weber L.. Fabrication of miniaturized biotechnical devices. SPIE Conference on Micromachining and Microfabrication Process Technology IV, Santa Clara, California, Sept 1998, vol 3511, pp 204-213_ Ruprecht R, Bacher W, Hausselt J H, Piotter V. Injection Molding of LIGA and LIGA-similar rnicrostructures using filled and unfilled thermoplastics. SPIE, vol 2639, pp146-158_ Fleming J G, Barron CC , Novel silicon fabrication process for high aspect ratio micromachined parts, SPIE vol 2639, 185-190_ Keller C G, Howe R T. Nickel-filled HEXSIL thermally actuated tweezers, 8th International Conference on Solid-State Sensors and Actuators, Stockholm, Sweden, June 25-29, 1995, pp 376-379. _Selvakumar A, Najafi K, High density vertical comb array microactuators fabricated using a novel bulk/polysilicon trench refill technology, Solid State Sensor and Actuator Workshop, Hilton head , SC Jun. 13-16 1994, pp 138-141_ Becker H., Dietz W.. Microfluidic devices for λ-TAS applications fabricated by polymer hot embossing. Proceedings of SPIE. Microfluidic Devices and Systems. 21-22 sept 1998, Santa Clara, pp177-182 _ Grzybowski B A, Haag R, Bowden N, Whitesides G M. Generation of micrometer-sized patterns for microanalytical applications using a laser direct-write method and microcontact printing. Anal. Chem, 1998, 70, 4645-4652_ Martynova L, Locascio E, Gaitan G, Kramer W, Christensen R G, MacCrehan W A.. Fabrication of plastic microfluid channels by imprinting methods. Anal. Chem. 1997, 69, 4763-4789).

These single unit production techniques can be used to micro-fabricate replication masters (for example micro-molds for injection molding of for reactive molding or hot-embossing micro-matrices), provided that two qualities are present: a high aspect ratio and a surface which is compatible with the requirements of the replication process. Indeed, some steps in the replication process are critical, especially the step of separation of the replication matrix from the newly replicated product.

Preferably, the complexity of the process which is selected to manufacture a replication matrix should be taken into account. For example, the skilled man can manufacture, with high accuracy, an injection micro-mold or a hot-embossing replication master using the LIGA technique, where a radiation emitted from a synchrotron (a very expensive, rare and heavy equipment) is used in the first steps. But new dry etching and mostly wet etching techniques, which have better performances, seem to be more flexible and present aspect ratios which are close to those of the LIGA technique. Thus, the anisotropic wet etching technique has been much improved (Hölke A., Henderson HT. Ultra-deep anisotropic etching of (110) silicon; J. Micromech. Microeng. 1999, 9, 51-p57). D'autres résultats montrent aussi un progrés dans les performances de la gravure humide isotrope (Wet chemical isotropic etching procedures of silicon—a possibility for the production of deep structured microcomponents. Schwesinger N, Albrecht A.. SPIE vol 3223, p 72-79).

Some single unit production techniques can be adjusted to mass production when the fabrication tools which are used, are miniaturized and can be massively used in parallel. This is a close perspective for laser ablation (because of the manufacturing of micro-lasers) and for etching with micro-tools, and this is further away for some dry etching techniques.

Mass fabrication is possible with some techniques such as: wet etching on silicon and its derivatives, glass, UV photolithography on photoresists, fabrication by successive addition of polymers layers (lamination) with use of sacrificial layers according to Webster et Mastrangelo (cited below), poly(dimethylsiloxane) (PDMS) plastic molding by injection with micro-mold, ceramic and metal molding, polymers hot embossing with an embossing micro-matrix.

Wet etching can be applied to all kinds of silicon and quartz derivatives, as well as to different kinds of glass (for example pyrex, boro-phospho-silicates, etc.) Regarding micro-fluidics, an important criteria is the compatibility with micro-electrophoresis, two dimensional micro-electrophoresis, and micro-electrochromatography which are used to separate the molecules. Important also is the compatibility with electro-osmosis to move the fluids, this technique having the advantage to avoid parts such as micro-valves and micro-pumps. As microelectrophoresis and 2D micro-electrophoresis, electro-osmosis and micro-electrochromatography request high potential differences. Consequently, these techniques are not fully compatible with the use of silicon.

However, they are compatible with the different kinds of glass and plastics (Manz A., Effenhauser C S, Burggraf N, Harrison D J, Seiler K, Fluri K. Electroosmotic pumping and electrophoretic separations for miniaturized chemical analysis systems. J. Micromech. Microeng., 1994, 4, 257-265. - Mac Cormick R M, Nelson J R, Alonso-Amigo M G, Benvegnu D J, Hooper H H. Microchannel electrophoretic separations of DNA in injection-molded plastic substrates. Anal. Chem., 1997, 69, 2626-2630_ Jacobson S J, Kutter J P, Culbertson C T, Ramsey J M. Rapid electrophoretic and chromatographic analysis on microchips, λ-TAS 1998, Banff, Canada, 315-318._ Microfabricated liquid chromatography columns based on collocated monolith support structures, λ-TAS 1998, Banff, Canada, 451-455. _ Paulus A., Williams S J, Sassi A P, Kao P H, Tan H, Hooper HH . Integrated capillary electrophoresis using glass and plastic chips for multiplexed DNA analysis, pp 94-103. SPIE Proceedings Vol 3515 #3515-08. _ P M Martin, D W Matson, Bennett W D, Hammerstrom D J. Fabrication of plastic microfluidic components. Polymer-based microfluidic analytical devices. SPIE Proceedings Vol 3515 #3515-19).

Forces other than the electro-osmotic force can be used to move the fluids where the use of micro-floodgates and micro-pumps can be minimized, such as capillary or thermocapillary or centrifugal force (Madou M J, Kellogg G J. The LabCD: a centrifuge-based microfluidic platform for diagnostics. SPIE Vol. 3259, pp. 80-93.) Other liquid circulation modes can be foreseen, such as the thermocapillary force (Bums M A, Mastrangelo C H, Sammarco T, Man F P, Webster J R, Johnson B N, Foerster B, Jones D, Fields Y, Kaiser A R, Burke D T. Microfabricated structures for integrated DNA analysis. P. N. A. S. 1996, vol. 93, pp5556-5561), ou les forces couplëes ä des alternances surfaces ou raies hydrophobes-surfaces ou raies hydrophiles (Jones D K, Mastrangelo C H, Bums M A, Burke D T. Selective hydrophobic and hydrophhilic texturing of surfaces using photolithographic photodeposition of polymers. SPIE vol 3515, 136-143_ Eastman Kodak.. Device for fluid supply of a micro-metering device; U.S. Pat. No. 5805189_ Beckton Dickinson. DNA microwell device and method.U.S. Pat. No. 5795748).

Silicon can be modified to acquire a compatibility with high potential differences (Characterization of silicon-based insulated channels for capillary electrophoresis, Van den Berg et al., λ-TAS 98, Canada, pp-327-330).

Transparency, which is a required quality in biological analysis, is offered by different kinds of glass (Kricka L, Wilding P, et al. Micromachined glass-glass microchips for in vitro fertilization. Clinical Chemistry, 1995, 41, 9, 1358-1359) and some plastics.

Some glasses, which present good compromises in doping and thermal expansion, can be easily assembled with silicon (Albaugh K B, Rasmussen D H. Mechanisms of anodic bonding of silicon to pyrex glass. Proc IEEE Solid State Sensors and Actuators Workshop. 1988. 109-110.)

Wet etching on glass, which is intrinsically isotropic, is perfectly controlled (A new fabrication method for borosilicate glass capillary tubes with lateral inlets and outlets. Gretillat M A, Paoletti F, Thiëbaud P, Roth S, Koudelka-Hep M, de Rooij N F. Sensors and Actuators A 60, 1997, 219-222. _ Corman T, Enoksson P, Stemme G. Deep wet etching of borosilicate glass using an anodically bonded silicon substrate as mask J. Micromech. Microeng., 1998, 8, 84-87.)

When compared to plastics, glass offers, among other qualities for biochemical analysis, the compatibility with fluorescence detection and a good coefficient of thermal exchange. However, they are only etched by using an isotropic mode, which limits, for example, the shape of micro-channels to a circular shape.

The plastics, even if they are endowed with a lower compatibility with fluorescence detection and a lower coefficient of thermal exchange when compared with glasses, have numerous other qualities, among which a low price. An improvement in the fluorescence detection by plastics and the removal of background noises (by modulating the migration speed of analytes and by using a LED light source) can be achieved, as previously reported (Shau-Chun W, Morris M D, Michigan University, 10th Frederick Conference on Capillary Electrophoresis, October 1999.)

The very low fabrication cost of the micro-fabricated plastic products results from the low price of raw material, from the simplicity of the production processes that can be used, and from the ability to be replicated by micro-molding or hot embossing, or even photolithography, for the photoresists-type plastics.

For the electrical circuits on plastic supports, metal wires can be laid down, once the product is finished. The support can also be labeled with a conductive ink.

Plastics can be classified as mentioned below:

photoresists, which can be done by photolithography, as, for example, PMMA for X-ray photolithography, SU-8 (negative photoresist) and Novolac from Hoescht and AZ 9260 (positive photoresist) for UV photolithography (Lorenz H, Despont M, Fahrni N, LaBianca N, Renaud P, SU-8: a low-cost negative resist for MEMS, J. Micromech. Microeng, 1997, 7, 121-124. _ .Loechtel B, Maciossek A, Surface micro components fabricated by UV depth lithography and electroplating, SPIE vol 2639, 174-184_ Conëdëra V, Le Goff B, Fabre N. Potentialities of a new positive photoresist for the realization of thick moulds, J. Micromech. Microeng, 1999, 9, 173-175. _ Guërin L J, Bossel M, Demierre M, Calmes S, Renaud P. Simple and low cost fabrication of embedded microchannels by using a new thick-film photoplastic. Proceedings of Transducers, Chicago, USA, 1997, pp 1419-1422.)

siliconized elastomers, and among them the poly(dimethylsiloxane) (PDMS), which can be used by simple molding (Mac Donald J C, Duffy D C, Anderson J R, Chiu D T, Hongkai Wu, Schueller O, Whitesides G M, Fabrication of microfluidic systems in poly(dimethylsiloxane), Electrophoresis 2000, 21, 27-40. _ Ocvirk G, Munroe M; Tang T, Oleschuk R, Westra K, Harrison D J, Electrokinetic control of fluid flow in native poly(dimethysiloxane) capillary electrophoretic devices, Electrophoresis 2000, 21, 107-115.)

a larger group of polymers which are/can be made, among other techniques, by injection and by hot-embossing. Among these polymers, the followings can be mentioned: polyamides (PA), polycarbonates (PC), polyoxymethylenes (POM), cyclopentadienenorbomen copolymer (COC), polymethylmethacrylates (PMMA), low density polyethylene (PE-Id), high density polyethylene (PE-hd), polypropylene (PP), polystyrenes (PS), cycloolefin copolymer (CO C), polyetheretherketone (PEEK) (Niggemann M., Ehrfeld W., Weber L.; Fabrication of miniaturized biotechnical devices, SPIE , vol 3511, pp 204-213_ Becker H, Gartner C, Polymer microfabrication methods for microfluidic analytical applications, Electrophoresis 2000, 21, 12-26.)

Some other plastics can also be micro-fabricated: polybutyleneterphtalate (PBT), polyphenylene ether (PPE), polysulfone (PSU), liquid crystal polymer (LCD), polyetherimide (PEI). Biodegradable polyactide can be also micro-fabricated.

PMMA and PC are currently used in injection molding and hot-embossing. COC is often cited for hot-embossing.

Mass fabrication processes on plastics are very various. The following processes can be considered:

wire imprinting (Locascio L F, Gitan M, Hong J, Eldefrawi M, Plastic microfluidic devices for clinical measurements, λ-TAS 1998, 367-370_ Chen Y H, Chen S H, Analysis of DNA fragments by microchip electrophoresis fabricated on poly(methyl methacrylate) substrates using a wire-imprinting method, Electrophoresis 2000, 21, 165-170.)

hot embossing (Becker H., Dietz W, Dannberg P. Microfluidic manifolds by polymer hot embossing for λ-TAS applications. λ-TAS 1998, Banff, Canada, 253-256. _ Kempen L U, Kunz R E, Gale M T. Micromolded structures for integrated optical sensors. SPIE vol 2639, 278-285.)

injection molding (Hagmann P, Ehrfeld W. Fabrication of microstructures of extreme structural heights by reaction injection molding, International Polymer Processing, 1989, Vol IV, No. 3, pp 188-195. _ Weber L, Ehrfeld W, Freimuth H, Lacher M, Lehr H, Pech B. . Micro-moulding—a powerful tool for the large scale production of precise microstructures. Proc. SPIE Symp. Micromachining and Microfabrication, 1996, vol 2879, pp 156-167.)

simple molding for siliconized elastomers (Kumar A, Whitesides G M. Appl. Phys. Lett, 1993, 63, 2002-2004_ Wilbur J L, Kumar A, kim E, Whitesides G M, Adv. Mat. 1994, 7, 600-604.)

photoresists photolithography, such as, for example, X-ray photolithographiy for PMMA, UV photolithography for photopolymer Epson SU-8.

In this last technique, three processes are often used (Renaud P., Van Lintel H, Heusckel M, Guerin L.. Photo-polymer microchannel technologies and applications. λ-TAS 1998, Banff. Canada, pp17-22.) Each process begins by laying down a first SU-8 layer which is exposed to UV. For the fabrication of a micro-channel, the first photoresist layer forms the bottom of the said micro-channel with a rectangular section. The second photoresist layer forms the vertical inner walls of the said micro-channel. The third photoresist layer finishes the said micro-channel by constituting the cover.

the “fill process.” A sacrificial layer (e.g. Araldite GT6063, Ciba-Geigy) is laid down between the second and the third photoresist layers At the end of the process, the sacrificial layer is dissolved.

the “mask process.” A thin metal layer is inserted on the second photoresist layer which is not developped. This second metal layer masks the micro-channel. A third photoresist layer is alid down, then illuminated. Then, the photoresist is developed inside and outside the said micro-channel.

the “lamination process”, a process without dissolution, where a SU-8 dry film is laminated over the construction made with the first photoresist layer, so as to seal it.

fabrication by successive polymer layers, with the use of sacrificial layers, such as, for example, the process developed by Webster J R, Burns M A, Mastrangelo C H, Man P F, Jones D K, Burke D T., (Webster J R, Burns M A, Burke D T., Mastrangelo CH, An inexpensive plastic technology for microfabricated capillary electrophoresis chips, λ-TAS 1998, 249-252), a technique which starts with deposition of parylene on polycarbonate or silicon, with subsequent use of sacrificial photoresist. The advantage of this technique is in the sealing of micro-channels which are naturally included in the method.

Laser microfabrication of plastics is also possible, but as a single unit production technique. For example, it can make use of direct bulk ablation or cutting-up of a joint which is inserted between two cover plates.

The plastics surface treatments depend on the application and on the material which is utilized. For example, an hydrophobic surface should often be modified into an hydrophilic surface.

In order to assemble and seal plastic micro-devices with cover plates, several solutions can be used. The followings can be considered, among others:

the sealing by rolling, at hot temperature, of a 30 micron-thin PET foil coated with a melting adhesive layer (most often a polymer) which is heated to its fusion point so that it is mixed with the substrate.

the sealing of a cover plate or the assembling of a complementary part, by gluing, or by pressure at hot temperature, or by laser welding, or by using ultrasounds, or by using plamas, etc.

Regarding in particular the electrophoretic separation of biological samples by micro-electrophoresis, these separations can be achieved on etched, molded or embossed supports (Liu Y, Foote RS, Culbertson C T, Jacobson S C, Ramsey R S, Ramsey J R. Electrophoretic separations on microchips. J. Microcolumn Separations, 2000, 12(7), 407-11; Alarie J P, Jacobson S C, Ramsey J M. Electrophoretic injection bias in a microchip valving scheme. Electrophoresis. 2001. Jan;22(2):312-7; Rocklin R D, Ramsey R S, Ramsey J M. A microfabricated fluidic device for performing twodimensional liquid-phase separations. Anal Chem. Nov. 1, 2000 ;72(21):5244-9; Liu Y, Foote R S, Jacobson S C, Ramsey R S, Ramsey J M. Electrophoretic separation of proteins on a microchip with noncovalent, postcolumn labeling. Anal Chem. Oct 1, 2000 ;72(19):4608-13; Khandurina J, McKnight T E, Jacobson S C, Waters L C, Foote R S, Ramsey J M. Integrated system for rapid PCR-based DNA analysis in microfluidic devices. Anal Chem. Jul. 1, 2000 ;72(13):2995-3000; Alarie J P, Jacobson S C, Culbertson C T, Ramsey J M. Effects of the electric field distribution on microchip valving performance. Electrophoresis. 2000 Jan;21(1):100-6.; Khandurina J, Jacobson S C, Waters L C, Foote R S, Ramsey J M. Microfabricated porous membrane structure for sample concentration and electrophoretic analysis. Anal Chem. May 1, 1999;71(9):1815; Waters L C, Jacobson S C, Kroutchinina N, Khandurina J, Foote R S, Ramsey J M. Multiple sample PCR amplification and electrophoretic analysis on a microchip. Anal Chem. Dec. 15, 1998 ;70(24):5172-6. ; Waters L C, Jacobson S C, Kroutchinina N, Khandurina J, Foote R S, Ramsey J M. Microchip device for cell lysis, multiplex PCR amplification, and electrophoretic sizing.Anal Chem. Jan 1, 1998;70(1):158-62; von Brocke A, Nicholson G, Bayer E. Recent advances in capillary electrophoresis/electrospray-mass spectrometry. Electrophoresis. 2001 Apr;22(7):1251-66; Schmid M G, Grobuschek N, Lecnik O, Gubitz G. Chiral ligand-exchange capillary electrophoresis. J Biochem Biophys Methods. Apr 24, 2001 ;48(2):143-54; Nishi H, Kuwahara Y. Enantiomer separation by capillary electrophoresis utilizing noncyclic mono-, oligo- and polysaccharides as chiral selectors. J Biochem Biophys Methods. Apr. 24, 2001 ;48(2):89-102; Castellanos-Serra L, Hardy E. Detection of biomolecules in electrophoresis gels with salts of imidazole and zinc II: a decade of research. Electrophoresis. 2001 Mar;22(5):864-73; Colyer C. Noncovalent labeling of proteins in capillary electrophoresis with laser-induced fluorescence detection. Cell Biochem Biophys. 2000;33(3):323-37; Bonneil E, Waldron K C. On-line solid-phase preconcentration for sensitivity enhancement in capillary electrophoresis. J Capillary Electrophor. 1999 May-Aug;6(3-4):61-73; Horvath J, Dolnik V. Polymer wall coatings for capillary electrophoresis.Electrophoresis. 2001;22(4):644-55; Kricka L J. Microchips, microarrays, biochips and nanochips: personal laboratories for the 21st century. Clin Chim Acta. 2001 May;307(1-2):219-23. Wang J, Chatrathi M P, Tian B; Brahmasandra S N, Ugaz V M, Burke D T, Mastroangelo C H, Bums M A. Electrophoresis in microfabricated devices using photopolymerized polyacrylamide gels and electrodedefined sample injection. Electrophoresis. 2001 Jan;22(2):300-11; Dutta D, Leighton D T Jr. Dispersion reduction in pressure-driven flow through microetched channels. Anal Chem. Feb. 1, 2001 1;73(3):504-13; Baldwin R P. Recent advances in electrochemical detection in capillary electrophoresis. Electrophoresis. 2000 Dec;21(18):4017-28; Bruin G J. Recent developments in electrokinetically driven analysis on microfabricated devices. Electrophoresis. 2000 Dec;21(18):3931-51; Krishnan M, Namasivayam V, Lin R, Pal R, Burns M A. Microfabricated reaction and separation systems. Curr Opin Biotechnol. 2001 Feb;12(1):92-8; Hutt L D, Glavin D P, Bada J L, Mathies R A. Microfabricated capillary electrophoresis amino acid chirality analyzer for extraterrestrial exploration. Anal Chem. Sep. 15, 1999 ;71(18):4000-6; Chiem N H, Harrison D J. Microchip systems for immunoassay: an integrated immunoreactor with electrophoretic separation for serum theophylline determination. Clin Chem. 1998 Mar;44(3):591-8; Woolley A T, Lao K, Glazer A N, Mathies R A. Capillary electrophoresis chips with integrated electrochemical detection. Anal Chem. Feb. 15, 1998 1;70(4):684-8; Colyer C L, Tang T, Chiem N, Harrison D J. Clinical potential of microchip capillary electrophoresis systems. Electrophoresis. 1997 Sep;18(10):1733-41).

In summary, for the fabrication of supports, silicon, glass, ceramic or plastic can be used.

Beds of fractionation micro-columns 2 can be etched on supports made of silicon or glass or ceramic. Beds of fractionation micro-columns 2 can be micro-molded or micro-embossed with silicon matrices when the support is made of plastic. Beds of fractionation micro-columns 2 can be coated with a thin hydrophobic or hydrophilic film.

When the support is made of plastic, the micro-particles network can be obtained by micro-molding or micro-embossing or photo-polymerization or thermopolymerization or can be made of micro or nano-rods which are inserted in the said beds of the said micro-columns.

A micro-particles network of fractionation micro-columns 2 which constitutes the stationary phase, can, for example, be obtained by photo-etching when the support is made of silicon or glass or ceramic. A micro-particles network of fractionation micro-columns 2 which constitutes the stationary phase, can, for example, be obtained by micro-molding, micro-embossing or in situ photopolymerization or thermopolymerization or can be made of micro or nano-rods which are inserted in the beds of the said micro-columns. A micro-particles network can be coated with a thin hydrophobic or hydrophilic film. A network of micro-particles can be submitted to coupling chemistries known by the skilled man to graft molecules which are characterized by their polarity or their amphipathicity.

Stationary phase coating methods are described below.

Stationary phase coating with peptides can be made by grafting which makes use of direct chemical coupling, or with spacer arms known by the skiled man, such as cyanogen bromide, or carbodiimide or carbonyldiimidazole, or oxirane or azlactone. A method which is more and more used is the immobilization of peptides on tentacular gels by using a fixation which results from an epoxy gel and azlactone derivatives activation (Pribl M. Bestimmung der Epoxyendgruppen in modifizierten chromatographischen Sorbentien un Gelen. Anal. Chem. 1980. 303. 113-116.)

Stationary phase coating with peptides can also be achieved through solid phase peptide synthesis, the solid phase which is used for synthesis being also the said stationary phase (Kumar K S, Rajasekharan Pillai V N, Das M R. Syntheses of four peptides from the immunodominant region of hepatitis C viral pathogens using PS-TTEGDA support for the investigation of HCV infection in human blood. J. Peptide Res., 2000, 56, 88-96.)

The stationary phases of the fractionation micro-columns 2 can be grafted with monolayers of lipids from cellular membrane such as, for example, phosphatidylcholines (Maget-Dana R. The monolayer technique: a potent tool for studying the interfacial properties of antimicrobial and membrane-lytic peptides and their interactions with lipid membranes. Biochim Biophys Acta. Dec. 15, 1999 ;1462(12): 109-40; Mozsolits H, Lee T H, Wirth H J, Perlmutter P, Aguilar M I. The interaction of bioactive peptides with an immobilized phosphatidylchoiline monolayer. Biophys. J, 1999, 1428-1444, 77, 3.)

Molecules detection by using micro-cantilevers is described inmore details below.

In general, the detection of specific interactions is achieved through the measurement of the variations of the microstructures mechanical properties. In most of cases, these microstructures take the form of micro-cantilevers (Betts T A, Tipple C A, Sepaniak M J, Datskos P G. Selectivity of chemical sensors based on micro-cantilevers coated with thin polymer films. Anal. Chimica Acta, 2000, 422, 89; Fagan B, Xue B, Datkos P, Sepaniak M.. Modification of micro-cantilevers sensors with sol-gels to enhance performance and immobilize chemically selective phases. Talanta, 2000, 53, 599; Wadu-Mesthrige K, Amro N A, Garno J C, Xu S, Liu G-Y. Fabrication of nanometer-sized proteins patterns using atomic force microscopy and selective immobilization. Biophysical Journal. 2001, 80, 1891-1899; Viani M B, Pietrasanta L I, Thompson J B, Chand A, Gebeshuber I C, Kindt J H, Richter M, Hansma H G, Hansma P K. Probing protein-protein interactions in real time. Nat Struct Biol. 2000 Aug;7(8):644-7; Luckham P F, Smith K. Direct measurement of recognition forces between proteins and membrane receptors. Faraday Discuss. 1998;(111):307-20; discussion 331-43; Micic M, Chen A, Leblanc R M, Moy V T. Scanning electron microscopy studies of protein-functionalized atomic force microscopy cantilever tips. Scanning. 1999 Nov-Dec;21(6):394-7; Bryant Z, Pande V S, Rokshar D S. Mechanical unfolding of a beta-hairpin using molecular dynamics. Biophys J. 2000 Feb;78(2):5849; Willemsen O H, Snel M M, van Noort S J, van der Werf K O, de Grooth B G, Figdor C G, Greve J. Optimization of adhesion mode atomic force microscopy resolves individual molecules in topography and adhesion. Ultramicroscopy. 1999 Oct;80(2):133-44; Willemsen O H, Snel M M, Kuipers L, Figdor C G, Greve J, de Grooth B G. A physical approach to reduce nonspecific adhesion in molecular recognition atomic force microscopy. Biophys J. 1999 Feb;76(2):716-24; Heinz W F, Hoh J H. Relative surface charge density mapping with the atomic force microscope. Biophys J. 1999 Jan;76(1 Pt 1):528-38; Eckert R, Jeney S, Horber J K. Understanding intercellular interactions and cell adhesion: lessons from studies on protein-metal interactions. Cell Biol Int. 1997.21(11):707-13; Oberlheithner H, Schneider S W, Henderson R M. Structural activity of a cloned potassium channel (ROMK) monitored with the atomic force microscope: the <<molecular sandwich>> technique PNAS, 1997, 94(25), 14144-9; You H, Yu L. Investigation of the image contrast of tapping-mode atomic force microscopy using protein-modified cantilever tips. Biophys J. 1997 Dec;73(6):3299-308; Tokunaga M, Aoki T, Hiroshima M, Kitamura K, Yanagida T. Subpiconewton intermolecular force microscopy. Biochem Biophys Res Commun. Feb. 24, 1997 ;231(3):566-9; Mitsui K, Hara M, Ikai A. Mechanical unfolding of alpha2-macroglobulin molecules with atomic force microscope. FEBS Lett. Apr. 29, 1996 ;385(1-2):29-33; Florin E L, Moy V T, Gaub H E. Adhesion forces between individual ligand-receptor pairs. Science. Apr 15, 1994 ;264(5157):415-7; Fritz J, Baller M K, Lang H P, Rothuizen H, Vettiger P, Meyer E, Guntherodt H, Gerber C, Gimzewski J K. Translating biomolecular recognition into nanomechanics. Science. Apr. 29, 2000 ;288(5464):316-8; Baller M K, Lang H P, Fritz J, Gerber C, Gimzewski J K, Drechsler U, Rothuizen H, Despont M, Vettiger P, Battiston F M, Ramseyer J P, Fornaro P, Meyer E, Guntherodt H J. A cantilever array-based artificial nose. Ultramicroscopy. 2000 Feb;82(1-4):1-9.)

Micro-cantilever detection can be achieved in a dynamic mode or a static mode.

In a static mode, the formation of a layer at the cantilever surface when there is a specific interaction, generates a mechanical constraint, which causes the flexion of the micro-cantilever. The sensitivity depends on micro-cantilever stiffness. In general, its value is about 0.1 N/m or below.

In a dynamic mode, the addition of a mass as a consequence of a specific interaction on a resonating micro-cantilever generates a decrease of its resonance frequency. The higher the resonance frequency and the quality factor, the higher is the sensistivity. In that case, stiffnesses are more important (between 1 and 100 N/m), and quality factors range between 10 and 500 in air, and between 1 and 10 in liquids. The sensitivity of such a detection is strongly increased when measurements are made in a vacuum (the quality factor can reach values superior to 104.)

Such an approach supposes the ability to measure the deflection in the static mode or the resonance frequency in the dynamic mode. Two kinds of measurements are possible. A first approach is based on laser optical deflection, which is the technique used in commercial atomic force microscope. This is an external detection system. This technique is very sensitive and can measure deflections which are inferior to 1 angstrom or variations in resonance frequency of a few Herz. This technique used in most cases (Patents WO 00/14539 or U.S. Pat. No. 5,445,008. Fritz et al., Science 288, 316, 2000.) The second approaches integrate the detection function with the micro-cantilever. These methods are genrally of the piezoresistive kind (U.S. Pat. No. 5,807,758 or Thaysen et al., MEMS, 401, Interlaken, January 2001) or the piezoelectric kind (U.S. Pat. Nos. 5,719,324 or 6,054,277.) The advantages of this second approach, even if the sensitivity is lower, are to increase the system compactness and more importantly, to obtain a direct electric transduction, which results in an easier integration in more complex systems.

Micro-cantilevers can be coated with a particular molecule which endows them with affinity or adsorption properties In a static mode (constraint effect), the coating (i.e. the specific treatment for a particular molecular recognition) on the surface of the micro-cantilever can be extended on the whole surface of the micro-cantilever. The constraint effect being the highest at the embedding part of the micro-cantilever, the active surface can be limited to the part of the micro-cantilever. In a dynamic mode, if the added mass is not supposed to modify the stiffness properties of the micro-cantilever, then the chemical coating should be positioned at the end of the micro-cantilever. However, an active part on the whole micro-cantilever surface is suitable.

Simple micro-cantilvever fabrication techniques are known, for the case where they are used with an external optical detection. Surface and volume micromachining which are associated with thin layer deposit, lead to the fabrication of silicon, silicon oxide, and silicon nitride micro-cantilevers. These micro-cantilevers can also be metallized (gold, platinium, etc.) Micro-cantilevers typically are a few hundreds microns long, a few dozens microns wide, and between a few tenths of microns (for the static mode detection) to two or three microns (for the dynamic mode) thick. Obviously, the mechanical properties of the material which is used and the micro-cantilever dimensions can modify their stiffness and their resonance frequency.

The fabrication of micro-cantilevers that integrate the detection function is more complex and requires more manufacturing steps. Moreover, it should be kept in mind that the number of electrical connections is increased with the number of micro-cantilevers.

In the case of a piezoelectric detection, there are two connections for each micro-cantilever, the first one for the suprior electrode, and the second one for the inferior electrode. The inferior electrode is genrally wired to the ground and all inferior electrodes are wired together to form a common mass. Thus, there are (n+1) electric connections for n piezo-electric micro-cantilevers, which markedly reduces the number of electrical connections. The other adavantage of a piezoelectric detection is it not only participates in the detection function, but also in the activation function (resonance setting in the dynamic mode) through the direct and inverse piezoelectric effect. However, there are two drawbacks in using a piezoelectric detection. The first one is that the realization techniques of piezoelectric thin layers (sol-gel or radiofrequency evaporation) are complex and their compatibility with silicon technologies can cause problems (notably the interface effects.) The second drawback is related to the ferroelectric and piezo-electric stability properties, which are subject to thermal drifts, the hysteresis effects, and the overall fatigue and ageing, which very strongly limits their life-time for a use in the dynamic mode.

In the case of piezoresitive detection (E. Cocheteau, C. Bergaud, B. Belier, L. Bary, R. Plana <<Formation of ultra-shallow p+/n junctions with BF2 implantation for the fabrication of improved piezoresistive cantilevers>>, Transducers '2001 / Eurosensors XV, Munchen, June 10-14, 2001), the number of connections is at least equal to two for each micro-cantilever, i.e. 2n electric connections for n micro-cantilevers. This number can be equal to 4 if piezoresistances are wired in a Wheatstone bridge, which results in 4n electric connections. The Wheatstone bridge integration leads to a reduced compactness of the complete system, when compared toa system with an external Wheatstone bridge. Moreover, it avoids the effects which result from thermal drifts. In a dynamic mode, the drawback of the piezoresitive detection is the need for an external mechanical excitation or for quality factors which should be high enough (>100) so that the resonance frequency be detectable in blank noise (thermomechanical excitation due to brownian movements). There are two advantages in using a piezoresistive detection. The first one is that piezoresistive micro-cantilever fabrication is relatively simple, and perfectly compatible with technologies which are used in micro-electronics on silicon. The second advantage is a better sensitivity, when compared to a piezoelectric detection.

The selectivity of micro-cantilevers 13, i.e. their ability to capture specific molecules, depends on the intrinsic polarity, the solvophobicity and the porosity of the material they are made of, or of the thin film they are coated with, and of the polarity and the solvophobicity of the functional groups they are grafted with. The selectivity of the micro-cantilevers 13 depends also on criteria such as ion exchange and affinity of functional groups, and on the successive conditions of micro-elution coming from a capture micro-channel or from a washing circuit and of the micro-extraction and microdigestion that are achieved upstream from the said micro-cantilevers 13.

The capture of a molecule, and notably of a protein, by a micro-cantilever 13 can be done by affinity. This is the case, for example, when the micro-cantilever is coated with an antibody. In this case, the micro-cantilever captures a precise known protein, thereby indicating its presence.

The capture of a molecule, and notably of a protein, by a micro-cantilever 13 can be done by adsorption. In this case, a given micro-cantilever is able to detect a class of proteins with similar adsorption properties. Unknown or searched proteins can then be detected. By comparing the patterns from different samples, differential patterns can be highlighted, notably differences in the detection obtained with micro-cantilevers 13. Subsequently, by reproducing the capture process with the same selection steps, proteins that were different between two samples can be isolated for further specific analysis.

In a realization mode, in which the analytical device does not include secondary fractionation micro-columns, a step by step elution or a gradient elution leads to use different secondary eluents that carry along different molecules according to their affinity with these said molecules and according to the micro-cantilevers affinity with these same molecules. Successive patterns are recorded at each elution step in a step by step elution process or at different times in a gradient elution process.

As already mentioned, successive washings of micro-cantilevers 13 can be performed, the retention of the secondary micro-elution products or micro-extracts or digestion products on micro-cantilvers 13 being measured by the flexion or by the vibration frequency of the said micro-cantilevers, several successive pattterns being recorded. The series of successive patterns on micro-cantilevers 13 of a first sample are, for example, compared to the corresponding series of successive patterns of a second sample. For a micro-cantilever washing, an eluent, which is able to drag along the molecules adsorbed on the micro-cantilevers 13, is flowed in the detection zones. According to the selectivity of the micro-cantilevers 13 in a detection zone, the composition of the eluent can be adjusted to drag along the retained molecules.

The circulation of a washing eluent in the detection zone can be achieved by using a capture micro-channel 8 in which a washing eluent is circulated.

In a variant of the invention, an additional washing channel that can be used to flow a washing eluent, is added directly upstream from the detection zone. Such an embodiment is preferable in the case where the analytical device includes secondary fractionation micro-columns.

On FIG. 12, the references are identical to those of FIG. 3. A fractionation micro-column 2 is intersected at the level of a terminal element by a capture micro-channel 8, is connected, upstream of the intersection, with a feeding channel 15 that can carry a secondary eluent and is connected, downstream of the intersection, with a secondary fractionation micro-column 10. A detection zone 11 that includes micro-cantilevers 13 is situated on the capture micro-channel 8 and downstream of the secondary fractionation micro-column 10.

A washing micro-conduit 70 comprises an inlet 71 that can be used to feed the system with a washing eluent and an outlet 72 that is connected with the capture micro-channel 8, downstream from the secondary fractionation micro-column 10 and upstream from the detection zone 11.

If a washing eluent is flowed through the capture micro-channel 8 and through the secondary fractionation micro-column 10, this washing eluent will drag along the molecules that are retained in the secondary fractionation micro-column 10. The washing micro-conduit 70 can be used to carry the washing eluent directly upstream from the detection zone, for a washing of the micro-cantilevers 13 without flowing through the secondary fractionation micro-column 10.

In a first embodiment of the analytical device, an additional detection can be performed, downstream from the detection zones 11 with micro-cantilevers 13, for example, by using mass spectrometry. Mass spectrometry methods are mentioned below.

In a second embodiment, after a comparison of successive patterns of two samples, a detection of the secondary micro-elution products or micro-extracts or digestion products is performed, however, only in detection zones 11 where the series of micro-cantilevers 13 patterns of the first sample are different from the series of the micro-cantilevers 13 patterns of the second sample.

Mass spectrometry detections using known methods can be used, as described in the following documents (Dongrë A R, Eng J K, Yates J R III. Emerging tandem-mass spectrometry techniques for the rapid identification of proteins. TiBTECH, 1997, 15, 418-425; Anderegg R J, Wagner D S, Blackburn R K, Opiteck G J, Jorgenson J W. A multidimensional approach to protein characterization. Journal of Protein Chemistry, 1997, 16, 5; Huang P, Jin X, Chen Y, Srinivasan J R, Lubman DM. Use of a mixed mode packing and voltage tuning for peptide mixture separation in pressurized capillary electrochromatography with an ion trap storage/reflectron Timeof-Flight mass spectrometer detector. Anal. Chem, 1999, 71, 1786-1791; Martin S E, Shabanowitz J, Hunt D F, Marto J A. Subfemtomole MS and MS/MS peptide sequence analysis using Nano-HPLC micro-ESI Fourier Transform Ion Cyclotron Resonance Mass Spectrometry; Anal. Chem 2000, 72, 4266-4274; Gatlin C L, Eng J K, Cross S T, Detter J C, Yates J R III. Automated identification of amino-acid sequence variation in proteins by HPLC/Microspray tandem Mass Spectrometry. Anal. Chem, 2000, 72, 757-763; Ji J, Chakraborty A, geng M, Zhnag X, Amini A, Bina M, Regnier F. Strategy for qualitative and quantitative analysis in proteomics based on signature peptides. Journal of Chromatography B, 2000, 745, 197-210; Van Pelt C K, Corso T N, Schultz G A, Lowes S, Henion J. A four-column parallel chromatography system for isocratic or gradient LC/MS analyses. Anal. Chem. 2001, 73, 582-5888; Patterson S D et al. Towards defining the urinary proteome using liquid chromatography-tandem mass spectrometry. Proteomics 2001, 1, 93-107 et 2, 108-117).

Mass spectrometry techniques, and solutions for interfacing liquid phase chromatography and the said mass spectrometry techniques were described were in the book authored by Niessen, <<Liquid Chromatography—Mass Spectrometry,)>> vol 79, Chromatographic Science Series, Jack Cazes ed., and the LC-MS coupling applied to protein analysis was more particularly described in the chapter 15, pp 501-537.

Mass spectrometry detection can notably be coupled, in a known manner, with two preliminary separation methods by liquid phase chromatography (abreviated notation is LC-MS where LC =liquid chromatography and MS = mass spectrometry) (Link A J, Eng J, Schieltz D M, Carmack E, Mize G J, Morris D R, Garvik B M, Yates J R III. Direct analysis of protein complexes using mass spectrometry. Nature Biotechnology, 1999, 17, 676-681; Washburn M P, Wolters D, Yates J R m. Large-scale analysis of the yeast proteome by multi-dimensional protein identification technology. Nature Biotechnology. 2001, 19, 242-247; Davis M T, Beierle J, Bures E T, Mac Ginley M D, Mort J, Robinson J H, Saphr C S, YU W, Luethy R, Patterson S. Automated LCLC-MS-MS platform using binary ion-exchange and gradient reversed-phase chromatography for improved proteomic analyses. Journal of Chromatography B, 2001, 752, 281-291; Zhou H, Watts J D, Aebersold R. A systematic approach to the analysis of protein phosphorylation, 2001, 375-382).

A mass spectrometry detection can also be coupled, in a known manner, with a separation of peptides and proteins in capillaries or on miniaturized supports with micro-channels or micro-columns, with micro-chromatography, micro-electrochromatography or micro-electrophoresis techniques (Xie S., Allington R. W., Svec F., Frechet J. Rapid reverse-phase separation of proteins and peptides using optimized moulded monolithic poly(styrene-co-divinylbenzene) columns; Josic D., Buchacher A., Jungbauer A. Monoliths as stationary phases for separation of proteins and polynucleotides and enzymatic conversion. Journal of Chromatography B, 2001, 752, 191-205; Walhagen K, Unger K K, Hearn M T W, Capillary electroendoosmotic chromatography of peptides, Journal of Chromatography A, 2000, 887, 165-185; Krull I S, Sebag A, Stevenson R, Specific applications of capillary electrochromatography to biopolymers, including proteins, nucleic acids, peptide mapping, antibodies, and so forth, Journal of chromatography A, 2000, 887, 137-136. ; He B, Ji J, Regnier F E. Capillary electrochromatography of peptides in a micro-fabricated system. Journal of Chromatography A, 1999, 853, 257-262.) Regarding detection by mass spectrometry, an ionization by nebulizationcan be used, such as, for example, mass spectrometry coupled with electrospray ionization (ESI-MS, or Electrospary Ionization Mass Spectrometry) or by desorption, such as, for example, the desorption on matrix and assisted with laser in MALDI mass spectrometry (Matrix Assisted Laser Desorption Ionization.)

A detection by mass specrtrometry by triple quadrupole or by ion trap or in tandem with electrospray ionization (ESI-MS-MS, or Electrospray Ionisation Tandem Mass Spectrometry) can be done where profit is drawn from the collision induced dissociation (CID) : each peptide is supposed to have a collision-induced dissociation mass spectrum which is archived in data bases (Figeys D, Ning Y, Aebersold R. A microfabricated device for rapid protein identification by microelectrospray Ion Trap mass Spectrometry. Anal Chem, 1997, 69, 3153-3160.)

Some documents describe more particularly mass spectrometry detection of peptides, proteins and carbohydrates.

Polypeptides are analyzed by mass spectrometry before or after enzymatic digestion (Roepstroff P. Mass spectrometry in protein studies from genome to function. Current Opinion in Biotechnology, 1997, 8, 6-13), by techniques which use ioinization by nebulization or by desorption.

Post-translational modifications of proteins can be analyzed by exposing the analytes to phosphatases and glycosylases (Qin J, Chait B T. Identifications and characterization of posttranslational modifications of proteins by MALDI Ion Trap mass spectrometry. Anal. Chem. 1997, 69, 4002-4009.)

When mass spectrometry analysis is done after digestion with a given endopeptidase, mass spectra can be compared data bases which contain the spectra of the residues resulting from digestion with the said endopeptidase.

In the MALDI mass spectrometry technique, samples can be laid down on poly(vinylidene difluoride) or polyurethane membranes (Mc Comb M E, Oleschuk R D, Manley D M, Donald L, Chow A, O'neil J D, Ens W, Stabding K G, Perreault H. Use of non-porous polyurethane membrane as a sample support for matrix-assisted laser desorption ionisation time-of-flight mass spectrometry of peptides and proteins. Rapid Commun Mass Spectrom, 1997, 11 (15), 1716-22.)

Glycoproteines can also be analyzed by mass spectrometry as peptides and proteins (Vinh J, Loyaux D, Redeker V, Rossier R. Sequencing of branched peptides with CID/PSD MALDI-TOF in the low picomoles range: application to the structural study of the posttranslational polyglycylation of tubulin. Anal. Chem, 1997, 69, 3979-3985. Harvey D J. Identification of protein-bound carbohydrates by mass spectrometry. Proteomics 2001, 1, 311-328. Yamagaki T, Nakanishi H. Ion intensity analysis of postsource decay fragmentation in curved-field reflectron matrix-assisted laser desorption/ionization time-of-flight mass spectrometry of carbohydrates: for structural characterization of glycosylation in proteome analysis. Proteomics 2001, 1, 329, 339).

References used in FIG. 4 are the same as used in FIG. 3. A first support 20 under the form of a plan plate includes a feeder channel 4 that is used to feed the system with a mobile phase and a zone 21 that is used to enrich the mobile phase with a sample. The first support 20 includes a fractionation micro-column 2 which is composed of a micro-channel 3, an inlet 3a which is connected with the feeder channel 4 downstream from an enriching zone 18 (a zone to enrich the mobile phase with the sample) and an evacuation outlet 3b. The first support 20 includes a capture microchannel 8 which intersects the micro-channel 3 or the fractionation micro-column 2 at the level of a terminal element 9 and a channel 15 that feeds the system with a secondary eluent and that is connected with the inlet of the capture micro-channel 8 upstream from the intersection with the fractionation micro-column 2.

A second support 22, which takes the form of a plate, includes a micro-conduit 23 which is connected to a secondary fractionation micro-column at one extremity and to a detection zone 11 equipped with micro-cantilevers 13 at the other extremity.

A third support 24 which also takes the form of a plan plate includes an evacuation channel 6.

The second and third supports, 22 and 24, respectively, are laid out on each side of the support 20, in parallel and bound with the first support, in such as way that the evacuation channel 6 of the third support 24 is in fluidic connection with the outlet 3b of the micro-channel 3 and that the micro-conduit 23 of the second support 22 is in fluidic connection with the capture micro-channel 8 downstream from the intersection with the micro-channel 3 or with the fractionation micro-column 2.

On FIG. 5, where references are the same as those which are used in FIG. 4, a first support 20 comprises multiple fractionation micro-columns 2 and multiple associated micro-channels 8. The second support 22 comprises multiple micro-conduits that are in fluidic connection with the micro-channels 8 and, multiple detection zones 11. The third support 24 comprises an evacuation channel 6 that is in fluidic connection with all of the outlets 3b of the micro-channels 3. The first, second and third supports, 20, 22 and 24, respectively, are laid out in parallel.

In a variant of the laid out supports which are figured on FIGS. 6 and 7, the second and third supports, 22 and 24, respectively, are laid out perpendicularly to the first support 20. On FIG. 6, the first support 20 includes a single fractionation micro-column 2. On FIG. 7, the first support 20 includes multiple fractionation micro-columns 2, the second and third support, 22 and 24, respectively, being laid out accordingly.

On FIG. 8, a support includes 4 groups of fractionation micro-columns 2 which are approximately laid out to form a star. The length range of the fractionation micro-columns 2 of the first group is the smallest. The length range of the fractionation micro-columns 2 of the second group are longer, the length range of the fractionation micro-columns 2 of the third group are even longer and the length range of the fractionation micro-columns 2 of the fourth group are the longest. The support includes a central enriching micro-column 25, of square form, which is in fluidic connection with all of the fractionation micro-columns 2 and is also connected with an introduction channel situated on a vertical plan and which is not figured on the FIG. 8.

In order to further improve the sensitivity of the analytical device, i.e. its capacity to detect all of the proteins, preliminary extractions can be performed before the introduction of the sample in the fractionation micro-columns.

On FIG. 9, a preliminary extraction tier comprises a support 31 (partially figured) which is equipped with multiple preliminary fractionation micro-columns 32 which are rectilinear and parallel and equal in length, a feeding channel 33 which is in fluidic connection with the fractionation micro-columns 32, an evacuation channel 34 which is in fluidic connection with the fractionation micro-columns 32 on the opposite side of the feeding channel 33. The preliminary fractionation micro-columns 32 are constituted by segments oif micro-channels which are equipped with intermediary separation means. The support 31 includes fluidic capture means 35 which takes the form of a capture micro-channel 36, the capture micro-channel 36 being fed from one side by the feeding conduit 37 and being in fluidic connection with a common collection channel 38 on the other side. Each capture micro-channel transversely crosses a fractionation micro-column 32 at the level of a terminal element which is situated next to the evacuation outlet of the fractionation micro-column 32, on the side of the evacuation channel 34.

The sample, which is is carried by a mobile phase through the feeding channel 33, flows through the fractionation micro-columns 32, where it is submitted to a separation according to the selectivity of the separation means of the fractionation micro-columns 32. The combination of multiple fractionation micro-columns 32 leads to a marked separation in the fractionation micro-columns 32 which have a small diameter, without limiting the flow of the sample-enriched mobile phase. The capture means 35 are used for successive captures of the sample components that are present at a given time at the level of the terminal element of intersection of the capture microchannels 36 with the fractionation micro-columns 32.

After a capture, a portion of the sample components is collected in the collection channel 38 and then carried toward the fractionation micro-columns and the detection zones, as previously described. The components which are separated during the preliminary extraction in a group of fractionationation micro-columns 32 which have a specific selectivity, will be better separated by adjusting the selectivity of the single or the group of fractionation micro-columns in which they will be transferred.

In a group of fractionation micro-columns which are used for preliminary extraction, the micro-columns have an equal length so that approximately the same components are collected at the extremity of each micro-column. Moreover, the products which are captured on different portions can be collectively evacuated in a separation channel. On the contrary, in a group of fractionation micro-columns which are used for analysis, the fractionation micro-columns can have different lengths to obtain a differential fractionation and each capture micro-channel is connected with an associated detection zone.

In an analytical device, multiple preliminary fractionation micro-columns can be included, each preliminary fractionation micro-column presenting a different selectivity and being connected with multiple groups of fractionation micro-columns which are used for analysis; each group of fractionation micro-columns used for analysis has a specific selectivity, preferably suited to the selectivity of the preliminary fractionation micro-columns.

On FIG. 10, where the references are the same as those used in FIG. 9, a support 31 includes a single capture micro-channel 36 which crosses successively the preliminary fractionation micro-columns 32 of a same group and is finally connected with the collection conduit 38.

On FIG. 11, where the references are the same as those used in FIG. 9, each capture micro-channel 36 includes an upstream segment 36a which is situated between the feeding conduit 37 and the intersection with the preliminary fractionation micro-column 32, and a downstream segment 36b which is situated between the preliminary fractionation micro-column 32 and the collection conduit 38. The upstream segment 36a and the downstream segment 36b are connected with the preliminary fractionation micro-column 32 at different points which are the extremities of a capture segment 40. The upstream segment 36a is connected to the downstream extremity of the capture channel 40 and the downstream segment 36b is connected with the upstream extremity of the capture channel 40.

At the time of capture, the separated components that are situated at the level of the capture channel 40 are captured. Thus, a larger number of components are captured during the same capture.

This capture mean, which is based on a capture micro-channel with shifted upstream and downstream segments, can also be applied on the main fractionation micro-columns, as presented on FIG. 14.

On FIG. 14, where references are the same as those which are used in FIG. 3, a support 1 comprises fractionation micro-columns 2, associated capture micro-channels 8 which are equipped of shifted upstream segments 8a and downstream segment 8b, these segments being connected with each fractionation micro-column 2, downstream and upstream , respectively, from a capture segment 40 The downstream segment 8b of a capture micro-channel 8 is connected, at its downstream extremity, with a detection zone 11, which is equipped with microcantilevers 13. An exit channel 45 is connected with all of the capture micro-channels 8, downstream from the detection zones 11, for the evacuation of the mobile phases and the components which are not retained by the selective micro-cantilevers. The support 1 comprises a washing micro-conduit 46 which is in fluidic communication with each of the capture micro-channels 8, directly upstream from the detection zones 11.

At the time of a capture, a capture eluent, which is different from the sample-enriched mobile phase, circulates at counter-current, in the capture segment 40. The eluent affinity for the components which are situated in the capture segment 40 is different from that of the mobile phase. The separation means being the same (i.e. those which are included in the fractionationation micro-column 2), the selectivity which is obtained when the capture eluent is flowed in the capture segment 40, is different from the selectivity which is obtained during the flow of the mobile phase. Consequently, during the capture, a secondary separation of the fractionation products which are situated in the capture segment 40, can be achieved.

To further improve the detection and the separation of components, a fractionation micro-column can comprise a terminal segment which presents a selectivity which is different from the selectivity of the upstream segment of the microcolumn. Taking into account the selectivity of the downstream segment, it is known that the components which have specific characteristics will migrate more quickly and will be the first to reach the terminal segment. The selectivity of the terminal segment is then adjusted for a supplementary separation of the components which more or less simultaneously reach the terminal segment of the fractionation micro-column.

This difference in selectivity of a segment of the fractionation micro-column can be applied to a fractionation micro-column, a secondary fractionation micro-column and a preliminary fractionation micro-column. Terminal segment refers to a segment which is situated upstream from an exit or capture means.

In the case of an application to fractionation micro-columns or to preliminary fractionation micro-columns, a terminal segment with a different selectivity upstream from a terminal capture element of a preliminary fractionation micro-column can be advantageously added. Thus, a precise preliminary extraction or fractionation can be achieved with the intent to isolate some components from a sample which contains numerous components, for a further more precise analysis.

On FIG. 13, where the references are the same as those used on FIG. 1, a support for analysis 1 comprises separate means to feed the system with samples and mobile phase.

A support 1 (partially figured) comprises a sample feeding channel 4 which comprises an introduction inlet 4a and an evacuation outlet 4b. The introduction inlets 3a of the fractionation micro-columns 2 are connected with the sample feeding channel 4.

The support 1 also comprises a mobile phase feeding channel 41, and mobile phase feeding micro-conduits 42 which comprise an introduction inlet 43 which is connected with the mobile phase feeding channel 41, and an exit outlet 44 which is connected with the sample feeding channel 4. Each evacuation outlet of a mobile phase feeding micro-conduit 42 is connected with the sample feeding channel 4 at the level of the introduction inlet 3a of a fractionation micro-column 2.

Each mobile phase feeding micro-conduit 42, which is followed by a fractionation micro-column 2, forms a channel which intersects the sample feeding channel 4.

In other words, a mobile phase feeding micro-conduit 42 can be considered as a segment of a micro-channel which is not fitted with separation means and which is situated upstream from a micro-channel segment which is fitted with separation means, thereby constituting a fractionation micro-column 2, the sample feeding micro-channel 4 being intersected with all of the micro-channels at the level of the introduction inlets 3a of the fractionation micro-columns 2.

When the system is in function, a sample circulates in the sample feeding channel 4, from the introduction inlet 4a toward the evacuation outlet 4b. To obtain the flow of a sample enriched mobile phase in the fractionation micro-columns 2 that will result in a separation and a detection, the flow of the mobile phase is induced in the mobile phase feeding micro-conduits 42. The mobile phase flows through the sample feeding channel 4 and is enriched in sample, then is collected downstream by the fractionation micro-columns 2.

The mobile phase feeding micro-conduits 42 are used at a given time to simultaneously inject equal quantities of sample enriched mobile phase in all of the fractionation micro-columns 2.

A difference in the flow of sample enriched mobile phase in a fractionation micro-column 3 could lead to variations in the detection which is done upstream from the fractionation micro-columns 3, notably if a simultaneous capture of the fractionation products at the level of the terminal elements of the fractionation micro-columns is planned.

In the case of an analytical device with a preliminary extraction tier, obviously, a sample capture zone upstream from the preliminary extraction tier can be added, as descibed above.

The detection of proteins and peptides was described without making distinctions. A biological cell contains a large number of proteins which can generate, after digestion, a larger number of peptides. In the case where the user wishes to analyse the peptides, he can plan a preliminary enzymatic digestion of the proteins , for example, by trypsin.

In order to improve the detection of a large number of peptides, one or several screening micro-columns can be added upstream from the micro-columns, and notably a size exclusion chromatography screening micro-column, as it was already mentioned.

Examples of possible analyses which are performed with an embodiment of the analytical device are provided thereafter.

### EXAPLE 1

Two biological samples can be analyzed, each sample being analyzed with 8 supports such as those which are presented on FIG. 8. On the supports, samples are separated by electro-chromatography supplemented by complementary pressure.

For example, each of the supports includes 4 groups of 1000 fractionation micro-columns which are asembled to form a lengths gradient, whith a minimum 20-micron length difference between two micro-columns, so that there is a 20-mm difference between the first and the last micro-column.

The lengths of the 1000 fractionation micro-columns of the first group range from 12 to 14 cm. The lengths of the 1000 fractionation micro-columns of the second group range from are from 14 to 16 cm. The lengths of the 1000 fractionation micro-columns of the third group range from 16 to 18 cm. The lengths of the 1000 fractionation micro-columns of the fourth group range from 18 to 20 cm. Such a format is called by the following abbreviation: Fractionation Chromatography, 4, 1000, 20, 1214, 14-16, 16-18, 18-20, or more compactly: FC, 4, 1000, 20, 12-20.

The supports which are utilized include capture micro-channels. The fractionation products which are adsorbed at a given time t on a fractionation microcolumn at the intersection with the said corresponding capture micro-channel are captured simultaneously, and undergo secondary, orthogonal, parallel and terminal micro or nano-elutions.

The capture micro-channels are connected with detection zones which are fitted with micro-cantilevers and an optical detection system.

The stationary phases of the fractionation micro-columns of the first support (FC, 4, 1000, 20, 12-20) are grafted with C30 alkyl molecules. Such a support can be called (FC, 4, 1000, 20, 12-20)-C30.

The stationary phases of the fractionation micro-columns of the second support (FC, 4, 1000, 20, 12-20) are grafted with butyl molecules. Such a support can be called (FC, 4, 1000, 20, 12-20)-butyl.

The stationary phases of the fractionation micro-columns of the third support (FC, 4, 1000, 20, 12-20) were grafted with cyclohexyl. Such a support can be called (FC, 4, 1000, 20, 12-20)-cyclohexyl.

The stationary phases of the fractionation micro-columns of the fourth support (FC, 4, 1000, 20, 12-20) are grafted with phenyl molecules. Such a support can be called (FC, 4, 1000, 20, 12-20)-phenyl.

The stationary phases of fractionation micro-columns of the fifth support (FC, 4, 1000, 20, 12-20) are grafted with ethyl molecules. Such a support can be called (FC, 4, 1000, 20, 12-20)-ethyl.

The stationary phases of the fractionation micro-columns of the sixth support (FC, 4, 1000, 20, 12-20) are grafted with amino-propyl molecules. Such a support can be called (FC, 4, 1000, 20, 12-20)-amino-propyl.

The stationary phases of fractionation micro-columns of the seventh support (FC, 4, 1000, 20, 12-20) are grafted with dihydroxypropyl molecules. Such a support can be called (FC, 4, 1000, 20, 12-20)-dihydroxypropyl.

The stationary phases of the fractionation micro-columns of the eight support (FC, 4, 1000, 20, 12-20) are grafted with cyanopropyl molecules. Such a support can be called (FC, 4, 1000, 20, 12-20)-cyanopropyl.

Each detection zone which is associated with a capture micro-channel comprises eight micro-cantilevers, each one being coated with a specific coating. For example, the first one is coated with C30 alkyl chains, the second one with octadecyl chains, the third one with octyl chains, the fourth one with butyl chains, the fifth one with cyclo-hexyl chains, the fifth one with ethyl chains, the sixth one with amino-propyl chains, the seventh one with dihydroxypropyl chains and the eight one with cyanopropyl chains.

The base solvents for primary elutions of the fractionation electrochromatography which are used on the supports (FC 4, 1000, 20, 12-20) can be ternary mixtures made of water, trifluoro-acetic acid, and acetonitrile. Six elution steps can be performed, the eluents which are used at each step presenting the following compositions (water, 10% acetonitrile, TFA 0,1%), (water, 15% acetonitrile, TFA 0,1%), (water, 20% acetonitrile, TFA 0,1%), (water, 25% acetonitrile, TFA 0,1%), (water, 30% acetonitrile, TFA 0,1%), (water, 35% acetonitrile, TFA 0,1%).

Five secondary elution steps are planned for each primary elution step, with eluents which successively present the following compositions (water, 15% acetonitrile, TFA 0,1%), (water, 16% acetonitrile, TFA 0,1%), (water, 17% acetonitrile, TFA 0,1%), (water, 18% acetonitrile, TFA 0,1%), (water, 19% acetonitrile, TFA 0,1%).

For each sample, the successive above-mentioned pattern series are recorded. The successive pattern series of the first sample is then compared to the corresponding successive pattern series of the second sample, and the pattern detection series are then archived in computer data bases.

Where differences are detected, the fractionation products are sampled and analyzed by one of the numerous methods which are known by the skilled man.

The process is applicable to any protein differential expression profile search for a given tissue, especially for the comparison of a healthy person and a person suffering from a pathology. It is also applicable to the comparison of the protein expression in two micro-organism strain (virus, bacteria, yeast) which are submitted to precise stimuli.

It is also applicable to the comparison of the protein differential expression profiles of strains of micro-organisms (virus, bacteria, yeast), or applicable to the comparison of the protein differential expression profiles of micro-organisms which are submitted to certain stimuli.

### EXAMPLE 2

The device can be used to compare the patterns of basic proteins in two samples. Each sample is analyzed on a support such as figured on FIG. 8 , of the (FC, 4, 1000, 20, 12-20) format, in accordance with references which are used in example 1.

These supports are made of plastic, and include fractionation micro-columns with macroporous monoliths which are synthesized in situ. The fractionation microcolumns have marked zwitterionic properties and contain of sulfoalkylbetaïn based copolymers such as (N,N-dimethyl-N-methacryloyloxyethyl-N-(3-sulfopropyl) ammonium betain (Viklund C, Sjorgen A, Irgum K, Nes I. Anal. Chem. 2001, 73(3), 444-52.)

Basic protein are separated in fractionation micro-columns by using different methods with primary eluents (eluent A: water ; eluent B: water, 10 mM sodium phosphate.)

The fractionation products are separated in secondary fractionation microcolumns, which are located downstream from the capture means. The secondary elutions are modulated by thiocyanate ions (primary eluent+10 mM thiocyanate) or by perchlorate ions (primary eluent+10 mM perchlorate.)

The successive pattern series of the first sample are compared to the corresponding successive pattern series of the second sample, the pattern series being then archived in a computer database.

The fractions are sampled at locations where differences are detected, and analyzed by one of the numerous methods which are known by the skilled man.

### EXAMPLE 3

The patterns of peptides and membrane proteins from two samples can be specifically compared.

For example, each sample is analyzed on two supports such as those which are displayed on FIG. 8, of the (FC, 4, 1000, 20, 12-20) format. The supports include fractionation micro-columns which are grafted with C4 alkyl chains.

In each of the first analysis supports which are used to analyze a sample, the membrane peptides are dissolved in dichloromethane (CH2C12)-hexafluoro-2-propanol (HFIP) (4:1) which contains traces of pyridine, then separated in fractionation microcolumns by using different primary elutions, in order to obtain successive patterns.

The primary elutions are made with mixtures of eluent A (formic acid-water (2:3)) on one hand, and eluent B (formic acid-2-propanol (4:1)) on the other hand. The primary elutions successively present the following compositions: (A 100%, B 0%); (A 80%, B 20%); (A 60%, B 40%); (A 40%, B 60%); (A 20%, B 80%); (A 0%, B 100%).

When a primary separation is achieved, three secondary elution steps are performed in the secondary fractionation micro-columns with secondary eluents which present the following compositions (A 95%, B 5%); (A 90%, B 10%); (A 85%, B 15%).

Membrane proteins are submitted to Triton X-114 extraction, ethanol 90% precipitation and redissolution in formic acid 65% before being analyzed in the second sample analysis support, where they are separated in the fractionation micro-columns by using successive primary elutions to obtain successive patterns.

The primary elutions are based on mixtures of eluent A (formic acid—water (65:35)) and eluent B (acetonitrile—water (65:35)). The primary elutions successively present the following compositions: (A 100%, B 0%); (A 80%, B 20%); (A 60%, B 40%); (A 40%, B 60%); (A 20%, B 80%); (A 0%, B 100%.)

When a primary separation is achieved, three secondary elution steps are perfomed in the secondary fractionation micro-columns, with secondary elutions which successively present the following compositions: (A 95%, B 5%); (A 90%, B 10%); (A 85%, B 15%.)

The successive pattern series of the first sample are then compared to the corresponding succesive pattern series of the second sample, the detection pattern series being then archived in a computer database. Fractionations are sampled at locations where differences are detected and analyzed by one of the numerous methods which are known by the skilled man.

### EXAMPLE 4

Data which are acquired during analyses perfomed with devices such as those described in the above-mentioned examples 1 to 3 can be used to design a fast test which can done with a miniaturized consumable device.

Such a device can include supports which are only fitted with fractionation micro-columns for which numerous comparison experiments have shown reproducible pattern differences for a specific pathology.

The analysis of a biological sample obtained from a healthy individual shows a first pattern A, whereas the analysis of a biological sample obtained from diseased individual shows a second pattern B. A first support (sA) is dedicated to pattern A examination, a second support is dedicated to pattern B examination.

The said supports (sA) and (sB) are equipped only with fractionation micro-columns where the differences in the composition of samples are observed. The supports are also fitted with capture micro-channels and detection zones with micro-cantilevers.

In this test which is targeted to the said pathology, the number of microcolumns, of micro-channels and of micro-cantilevers are very limited. The selected fractionation micro-columns and more precisely, the selectivities of the separation methods in relation with the solid and liquid phases which are used, are adjusted to onbly highligth the absence or the presence of the specific proteins which are markers of the targeted pathology.

An analytical device is designed for the comparative chemical or biochemical analysis of chemical or biochemical samples, such as crude cellular extracts, or cellular extracts which result from prior extraction or enzymatic digestion.

A biological sample is characterized, in particular, by its composition in proteins, glycoproteins, phosphoproteins, lipoproteins, lipids, polysaccharids, hormones, vitamins which are permanently or occasionally synthesized by the cells, in accordance with the tissue or a physiological or pathological status. According to an embodiment of the invention, an analytical device can be designed for the detection of these constituents after separation and patterns recording.

An analytical device can make use of multiple fractionation micro-channels or micro-columns which are assembled to form a length gradient, and micro-electrophoresis or micro-chromatography or micro-electrochromatography.

A group of fractionation micro-columns can be associated to a second or even a third group of separation micro-channels or micro-columns, each separation micro-channels or micro-columns of the first group being individually connected to the separation micro-channels or micro-columns of the said second group.

In the above described micro-cantilever detection method, the micro-cantilever selectivity can be adjusted to the fractionation micro-columns to which they are associated. A supplementary detection can be done by mass spectrometry. The analytical device can also make use of other detections methods, which are known by the skilled man, such as fluorescence, surface plasmon resonance (SPR), nuclear magnetic resonance (NMR), electrochemistry, spectrophotometry, this list not being restrictive.

This invention can be used to obtain an analytical device which is used to separate the components of a sample, according to different selectivites, and to detect the components.

Successive separations with different selectivities can be performed in order to improve the separation of the constituents. An analytical device can be used to perform an exhaustive and fast analysis of a sample, and a comparison with another sample.

The detection of constituents by use of micro-cantilever which are linked to analytical means can be followed by a storage of the data and comparisons of the recorded data. According to an embodiment of the invention, the analytical device can be miniaturized.

Obviously, the invention is not limited to the modes of realization and the embodiments which are described above. Modifications can be introduced without going out the scope of the invention.

1. Device for the chemical or biochemical analysis of biological or chemical samples, notably for a comparative analysis of at least two samples, comprising multiple fractionation micro-columns (2) for the fractionation of sample components, each fractionation micro-column (2) comprising at least a micro-channel segment fitted with intermediate separation means, the microchannel segment comprising an inlet for the introduction of a sample-enriched mobile phase and an outlet for the evacuation of the fluids and situated at a teminal extremity, characterized by the fact that it comprises capture fluidic means (7), for the capture of the fractionated products, which are situated at the level of a terminal element of each fractionation micro-columns (2) and upstream from the evacuation outlet, by capture micro-channels which are used to collect the fractionation products and by groups of selective micro-cantilevers (13) which are associated with the fractionation micro-columns (2), are situated downstream from the capture micro-channels, a micro-cantilever (13) being fitted with detection means which are associated with analytical means.

2. Device according to the claim 1 and characterized by the fact that a fractionation micro-column (2) or a group (3) of fractionation micro-columns is different from another micro-column (2) or another group (3) of fractionation micro-columns by an element of length, the terminal element being situated on each fractionation micro-column (2) at a given distance from the terminal extremity of the fractionation micro-column (2).

3. Device according to any of the claims 1 or 2 and characterized by the fact that each fractionation micro-column (2) is different from the next longer fractionation micro-column (2) by a given element of length.

4. Device designed according to any of the previous claims and characterized by the fact that it comprises secondary fractionation micro-columns (20) which are situated downstream from the capture fluidic means (7) and upstream from the group of micro-cantilevers (13) which is associated with a fractionation micro-column (2) and used for the secondary fractionation of the captured fractionation products.

5. Device designed according to any of the previous claims, characterized by the fact that it comprises several groups of fractionation micro-columns (2), each group of fractionation micro-columns (2) having a selectivity which is determined by the separation means of in the fractionation microcolumns (2) comprising a stationary phase, coated or not coated, and/or associated with separation electrical means.

6. Device designed according to claim 5 and characterized by the fact that it comprises a support (1) equipped with multiple groups of fractionation micro-columns (2), capture means (7), associated groups of micro-cantilevers (13) and a feeding channel for all of the fractionation micro-columns.

7. Device designed according to any of the previous claims and characterized by the fact that the selective micro-cantilevers (13) comprise detection means which are based on their surface status or coating status of their surface or their chemical nature or the chemical nature of the coating on their surface.

8. Device designed according to any of the previous claims and characterized by the fact that the diameter of the micro-columns (2) ranges between 1 micron (λm) and 100 microns (λm).

9. Device designed according to any of the previous claims and characterized by the fact that it comprises a fractionation support (1) equipped with fractionation micro-columns (2) and a detection support (8) equipped with micro-cantilevers (13), the supports being approximately flat and being laid out in an approximately parallel or perpendicular way.

10. Device designed according to any of the previous claims and characterized by the fact that it comprises at least one tier of preliminary fractionation micro-columns (32) which is situated upstream from the fractionation micro-columns (2) and comprises at least one preliminary fractionation micro-column (32), capture fluidic means (36, 37, 38) which are situated at the level of a terminal element of the preliminary fractionation microcolumn (32) and a collection channel that is used to collect the preliminary fractionation products to the fractionation micro-columns.

11. Device designed according to the claim 10 and characterized by the fact that the preliminary fractionation tier comprises multiple preliminary fractionation micro-columns (32), each of them being intersected by a capture channel (36), the capture micro-channel (36) being connected to a collection channel (38).

12. Device designed according to the claim 10 and characterized by the fact that the preliminary fractionation tier comprises multiple preliminary fractionation micro-columns (32) and a capture micro-channel (36) which successively intersects the preliminary fractionation micro-columns and is connected with a collection channel (38).

13. Device designed according to any of the previous claims and characterized by the fact that a fractionation micro-column comprises a terminal segment which is fitted with separation means that are different from the intermediate separation means.

14. Device designed according to any of the previous claims and characterized by the fact that the capture fluidic means which are associated with a fractionation micro-column (3, 32) comprise a capture micro-channel (8,36) which comprises an upstream portion (8a, 36a) which is connected with the downstream extremity of a capture segment (40) of the micro-column (3, 32), and a downstream segment (8b, 36b) which is connected to the upstream extremity of the capture segment (40).

15. Device designed according to any of the previous claims and characterized by the fact that it comprises a washing micro-conduit (70) for the selective micro-cantilevers and connected with capture micro-channels (8) directly upstream from the micro-cantilevers.

16. Group of chemical or biochemical comparative analyses of at least two chemical or biological which is characterized by the fact that it comprises at least two devices for the chemical or biochemical analysis of biological or chemical samples, notably for a comparative analysis of at least two samples, these devices comprising multiple fractionation micro-columns (2) for the fractionation of sample components, each fractionation micro-column (2) comprising at least a micro-channel segment fitted with intermediate separation means, the micro-channel segment comprising an inlet for the introduction of a sample-enriched mobile phase and an outlet for the evacuation of the fluids and situated at a teminal extremity, characterized by the fact that it comprises capture fluidic means (7), for the capture of the fractionated products, which are situated at the level of a terminal element of each fractionation micro-columns (2) and upstream from the evacuation outlet, by capture micro-channels which are used to collect the fractionation products and by groups of selective micro-cantilevers (13) which are associated with the fractionation micro-columns (2), are situated downstream from the capture micro-channels, a micro-cantilever (13) being fitted with detection means which are associated with analytical means.

17. Process for the chemical or biochemical analysis of chemical or biological samples characterized by the fact that the differential fractionation of a sample enriched mobile phase is performed, that different fractionation products are simultaneously captured and that each fractionation products is analyzed by a selective micro-cantilever group.

18. Process performed according to claim 17 and characterized by the fact that a captured fractionation product is fractionated before being analyzed.

19. Process performed according to any of the claims 17 or 18 and characterized by the fact that the components of a fractionation product are detected by micro-cantilevers (13), according to polarity, solvophobicity or porosity characteristics of the micro-cantilever material or of the micro-cantilever coating, or according to the polarity or solvophobicity chraracteristics or ion exchange or affinity with the functional groups which are grafted on the microcantilevers.

20. Process performed according to any of the claims 17 to 19 and characterized by the fact that a sample is fractionated by chromatography, by micro-electrophoresis or by interactions with nano-electrodes.

21. Process performed according to any of the claims 17 to 20 and characterized by the fact that the deviation or the vibration frequency of the micro-cantilevers (13) are analyzed.

22. Process performed according to any of the claims 17 to 21 and characterized by the fact that fractionation products are analyzed by mass spectrometry, before or after the analysis by micro-cantilevers (13).

23. Process performed according to any of the claims 17 to 22 and characterized by the fact that a first sample is analyzed, a second sample is analyzed and the results of both samples are compared.

24. Process performed according to the claim 23 and characterized by the fact that the first and second samples are analyzed with the intent to compare the protein patterns of the samples by selective micro-cantilevers which are able to reveal different protein patterns.

25. Process performed according to any of the claims 17 to 24 and characterized by the fact that a preliminary extraction is performed on a sample before the differential fractionation of the sample.
